(19) United States
(12) Patent Application Publication
(10) Pub. No.: US 2025/0302268 A1
(43) Pub. Date: Oct. 2, 2025

(54) CLEANING SYSTEM AND METHOD FOR CONTROLLING THE SAME

(71) Applicant: SAMSUNG ELECTRONICS CO., LTD., Suwon-si (KR)

(72) Inventors: Sinae KIM, Suwon-si (KR); Jongseok PARK, Suwon-si (KR); Byeongwoo AHN, Suwon-si (KR)

(73) Assignee: SAMSUNG ELECTRONICS CO., LTD., Suwon-si (KR)

(21) Appl. No.: 19/050,777

(22) Filed: Feb. 11, 2025

Related U.S. Application Data
(63) Continuation of application No. PCT/KR2025/099248, filed on Feb. 4, 2025.

(30) Foreign Application Priority Data
Mar. 26, 2024 (KR) 10-2024-0041433
Jun. 20, 2024 (KR) 10-2024-0080585

(51) Int. Cl. A47L 11/40; A47L 11/28; B08B 3/00; F26B 21/00

(52) U.S. Cl. CPC A47L 11/4091; A47L 11/28; A47L 11/4002; A47L 11/4011; A47L 11/4055; B08B 3/00; F26B 21/004; A47L 2201/028; B08B 2230/01

(57) ABSTRACT

A cleaning system including a cleaner including a main body, and a mop; and a station to which the cleaner is dockable, the station including a washing chamber, a water storage container, a heating device, and a drying device, wherein the station is configured to, while the cleaner is docked to the station, receive the mop in the washing chamber, based on a start of a washing process, drive the heating device to heat water supplied from the water storage container to produce steam which is supplied to the washing chamber, and, while the steam is supplied to the washing chamber, drive the drying device to supply air to the washing chamber so that at least a portion of the air flows to the main body of the cleaner.

### CROSS-REFERENCE TO RELATED APPLICATIONS

This application is a continuation application of International Application No. PCT/KR2025/099248, filed on Feb. 4, 2025, which is based on and claims the benefit of Korean Patent Application Number 10-2024-0041433, filed on Mar. 26, 2024, and Korean Patent Application Number 10-2024-0080585, filed on Jun. 20, 2024, the disclosures of which are incorporated by reference herein in their entireties.

### TECHNICAL FIELD

The disclosure relates to a cleaning system including a cleaner and a station, and a method for controlling the cleaning system.

### BACKGROUND ART

Cleaners may include a manual cleaner that is operated by a user to move across a cleaning area to remove dirt and other debris from the floor, and a robot cleaner that moves across a cleaning area and automatically cleans the cleaning area by vacuuming dirt and other debris from the floor without user operation.

Recently, robot cleaners have been developed that not only vacuum foreign substances, such as dirt and dust from the floor, but also wipe the dirt and dust off the floor. The robot cleaners may perform wet cleaning with a mop.

Robot cleaners and cordless manual cleaners are equipped with batteries, allowing free movement on the cleaning area without being connected to a power cord.

A cordless cleaner and robot cleaner may be docked to a station to charge a battery.

Recently, stations have been developed that not only charge a battery of a cleaner while being placed, but also store dust drawn in from a cleaner's dust collector in a station's dust collector, or wash and/or dry a mop of the cleaner.

### DISCLOSURE

The disclosure provides a cleaning system that may prevent water from splashing during a washing process, and a method for controlling the same.

The disclosure provides a cleaning system that may prevent electrical hazards caused by steam during a washing process, and a method for controlling the same.

The disclosure provides a cleaning system that may prevent water from forming around a main body of a cleaner and on a station due to steam discharged to the outside during a washing process, and a method for controlling the same.

The disclosure provides a cleaning system that may prevent docking failures caused by water forming on a docking sensor, and a method for controlling the same.

Technical objects that may be achieved by the disclosure are not limited to the above-mentioned objects, and other technical objects not mentioned will be clearly understood by one of ordinary skill in the art to which the disclosure belongs from the following description.

Aspects of embodiments of the disclosure will be set forth in part in the description which follows and, in part, will be apparent from the description, or may be learned by practice of the presented embodiments.

According to an embodiment of the disclosure, a cleaning system includes a cleaner including a main body, and a mop; and a station to which the cleaner is dockable, the station including a washing chamber, a water storage container, a heating device, and a drying device, wherein the station is configured to, while the cleaner is docked to the station, receive the mop in the washing chamber, based on a start of a washing process, drive the heating device to heat water supplied from the water storage container to produce steam which is supplied to the washing chamber, and, while the steam is supplied to the washing chamber, drive the drying device to supply air to the washing chamber so that at least a portion of the air flows to the main body of the cleaner.

According to an embodiment of the disclosure, the cleaner may be configured to, based on the start of the washing process, lower the mop to a first position, and, based on an end of the washing process, lift the mop to a second position higher than the first position.

According to an embodiment of the disclosure, the air supplied to the washing chamber while the mop is in the first position may flow relatively more to an outside of the washing chamber than to an inside of the washing chamber.

According to an embodiment of the disclosure, the station may include a guide member configured to divide a flow path of the air supplied to the washing chamber into a first flow path and a second flow path, and contact the mop while the mop is in the first position so that air flowing through the first flow path is directed to an outside of the washing chamber and air flowing through the second flow path is directed to an inside of the washing chamber.

According to an embodiment of the disclosure, the guide member may be configured to be spaced apart from the mop while the mop is in the second position so that the air flowing through the first flow path and the air flowing through the second flow path flows to the outside of the washing chamber and the inside of the washing chamber.

According to an embodiment of the disclosure, the station may include a guide member configured to divide a flow path of air supplied to the washing chamber into a first flow path and a second flow path, contact the mop while the mop is in the first position so that the washing chamber is closed by the mop, and be spaced apart from the mop while the mop is in the second position so that the washing chamber is open.

According to an embodiment of the disclosure, the station may be configured to, based on the end of the washing process, stop driving the heating device, and drive the drying device while the mop is in the second position to perform a drying process.

According to an embodiment of the disclosure, the station may be configured to drive the heating device in response to completion of lowering the mop to the first position.

According to an embodiment of the disclosure, the cleaner may be configured to lift the mop to the second position in response to the heating device no longer being driven.

According to an embodiment of the disclosure, the cleaner may include an intake motor. The cleaner may be configured to drive the intake motor while the steam is supplied to the washing chamber so that air introduced into the main body flows to an outside of the main body.

According to an embodiment of the disclosure, the cleaner may include a first sensor, and the station may include a second sensor. The first sensor and the second sensor may be configured to face each other while the cleaner is docked to the station so as to sense the cleaner being docked to the station.

According to an embodiment of the disclosure, the cleaner may include a first sensor, and the station may include a second sensor. The first sensor and the second sensor may be configured to face each other while the cleaner is docked to the station so as to sense the cleaner being docked to the station. The cleaner may include an outlet configured to discharge air drawn in by the intake motor. The outlet may be positioned below the first sensor.

According to an embodiment of the disclosure, the air discharged through the outlet by driving the intake motor may flow into a space between the first sensor and the second sensor.

According to an embodiment of the disclosure, a portion of the at least a portion of the air that flows to the main body of the cleaner may flow into a space between the first sensor and the second sensor.

According to an embodiment of the disclosure, provided is a method of controlling a cleaning system including a cleaner including a main body and a mop, and a station to which the cleaner is dockable, the station including a washing chamber, a water storage container, a heating device, and a drying device, the method comprising, while the cleaner is docked to the station, receiving the mop in the washing chamber; based on a start of a washing process, driving the heating device to heat water supplied from the water storage container to produce steam which is supplied to the washing chamber; and, while the steam is supplied to the washing chamber, driving the drying device to supply air to the washing chamber so that at least a portion of the air flows to the main body of the cleaner.

### DESCRIPTION OF DRAWINGS

These and/or other aspects of the disclosure will become apparent and more readily appreciated from the following description of embodiments, taken in conjunction with the accompanying drawings listed below.

FIG. 1 illustrates a state in which a cleaner is away from a station in a cleaning system according to an embodiment of the disclosure.

FIG. 2 illustrates a state in which a cleaner is seated on a station in a cleaning system according to an embodiment of the disclosure.

FIG. 3 is a rear view of the cleaning system shown in FIG. 2.

FIG. 4 is a view illustrating a cleaner according to an embodiment of the disclosure.

FIG. 5 is a rear view of the cleaner shown in FIG. 4.

FIG. 6 is a view illustrating a lower portion of the cleaner shown in FIG. 4.

FIG. 7 is a view illustrating a station according to an embodiment of the disclosure.

FIG. 8 is a view illustrating a rear portion of the station shown in FIG. 7.

FIG. 9 is a view illustrating a rear surface of the station shown in FIG. 7.

FIG. 10 is a view illustrating a portion of a station according to an embodiment of the disclosure.

FIG. 11 illustrates a state in which a washing frame is separated from a washing chamber in a station according to an embodiment of the disclosure.

FIG. 12 is a side cross-sectional view of a station based on a heating device according to an embodiment of the disclosure.

FIG. 13 is a side cross-sectional view of a station based on a drying device according to an embodiment of the disclosure.

FIG. 14 is a control block diagram of a cleaner according to an embodiment of the disclosure.

FIG. 15 is a control block diagram of a station according to an embodiment of the disclosure.

FIG. 16 is a flowchart illustrating an example method for controlling a cleaning system according to an embodiment of the disclosure.

FIG. 17 is a schematic view illustrating a flow of air supplied by a drying device of a station while a mop of a cleaner is in a first position according to an embodiment of the disclosure.

FIG. 18 is a schematic view illustrating a flow of air while an intake motor of a cleaner is driven according to an embodiment of the disclosure.

FIG. 19 is a schematic view illustrating a flow of air supplied by a drying device of a station while a mop of a cleaner is in a second position according to an embodiment of the disclosure.

### MODES OF THE DISCLOSURE

Embodiments described in the specification and configurations shown in the accompanying drawings are merely examples of the disclosure, and various modifications may replace the embodiments and the drawings of the disclosure at the time of filing of the application. Terms used herein are for describing embodiments only and are not intended to limit the disclosure.

For example, a singular form of a noun corresponding to an item may include one item or a plurality of the items unless context clearly indicates otherwise.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it may be directly on the other component or intervening components may also be present.

The terms “front,” “rear,” “left,” “right,” “upper,” “lower”, and the like are defined with reference to the drawings, and are not intended to limit the shape and position of any element. For example, the front side may be defined as the +X side and the rear side may be defined as the −X side. For example, based on the drawing, the right side may be defined as the +Y side and the left side may be defined as the −Y side. For example, based on the drawing, the upper side may be defined as the +Z side and the lower side may be defined as the −Z side.

It will be understood that, although the terms first, second, etc. may be used herein to describe various elements, these elements should not be limited by these terms.

The terms such as “˜portion”, “˜device”, “˜block”, “˜member”, “˜module”, and the like may refer to a unit for processing at least one function or act. For example, the terms may refer to at least one process processed by at least one hardware, such as field-programmable gate array (FPGA)/application specific integrated circuit (ASIC), software stored in memories or processors.

Hereinafter, embodiments of the disclosure is described in detail with reference to the accompanying drawings. Like reference numerals throughout the disclosure denote like elements.

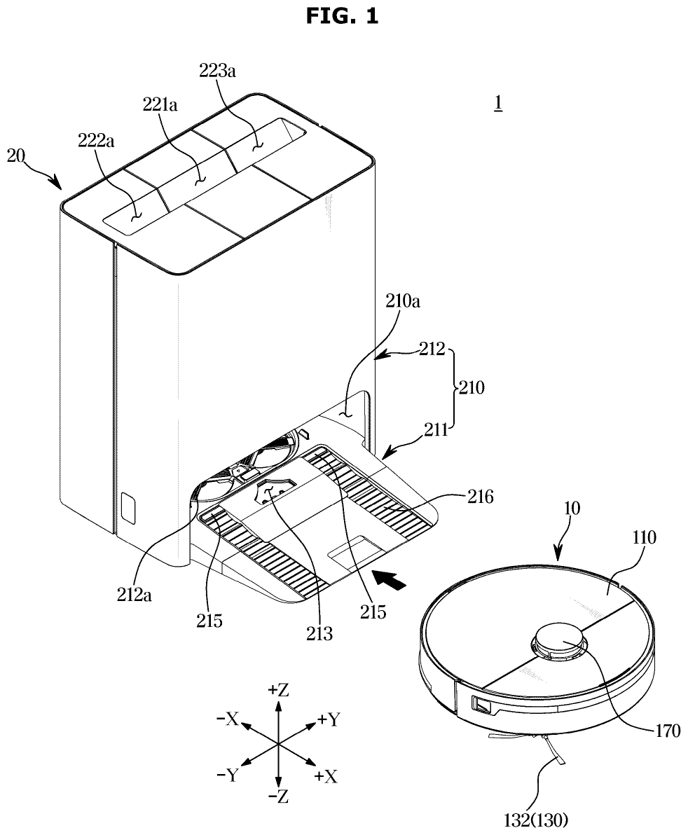

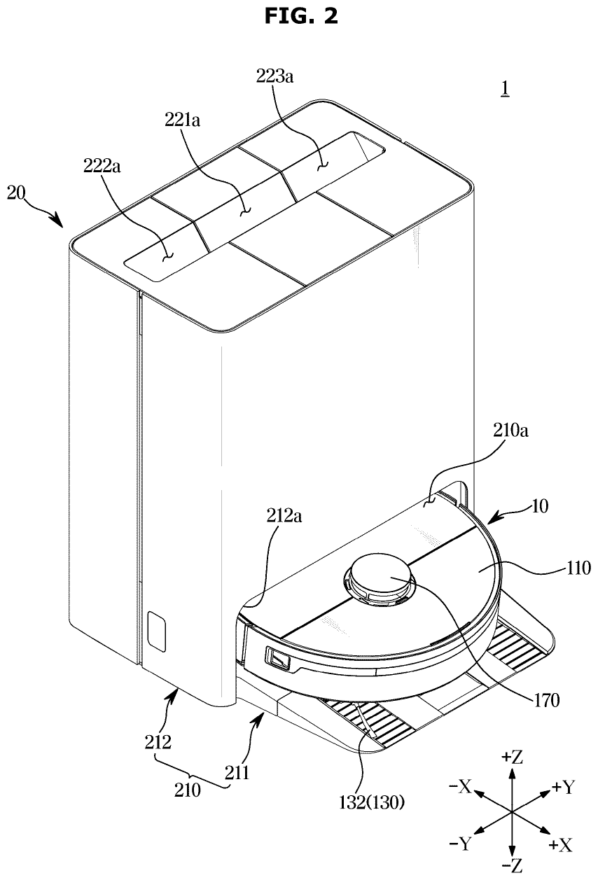

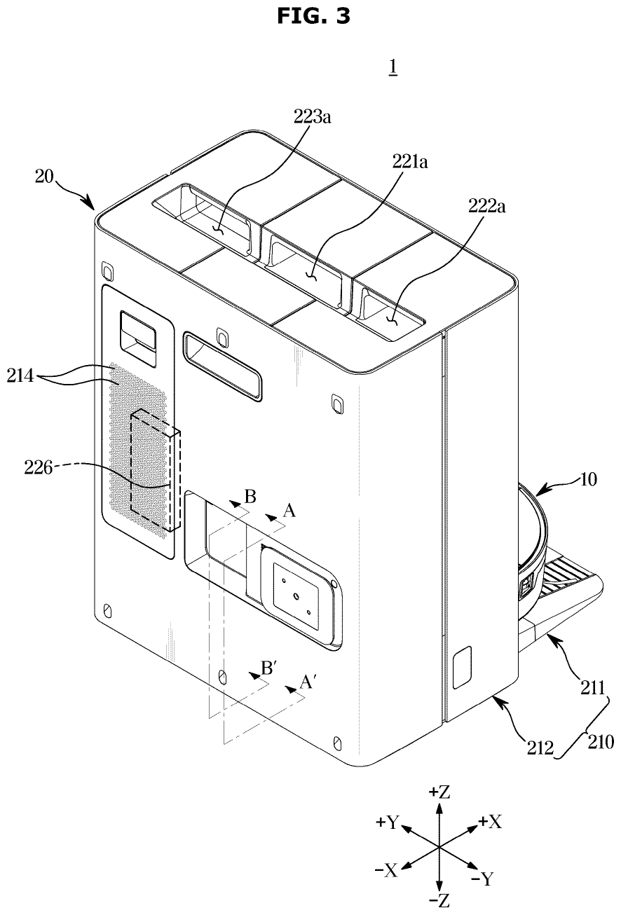

FIG. 1 illustrates a state in which a cleaner is away from a station in a cleaning system according to an embodiment. FIG. 2 illustrates a state in which a cleaner is seated on a station in a cleaning system according to an embodiment. FIG. 3 is a rear view of the cleaning system shown in FIG. 2.

Referring to FIG. 1 to FIG. 3, the cleaning system 1 may include a cleaner 10 and a station 20. The cleaning system 1 may be referred to as a cleaning apparatus 1.

Hereinafter, it is assumed that the cleaner 10 is a robot cleaner and the station 20 is a station to which the robot cleaner 10 is dockable. However, the cleaner 10 may be a corded or cordless cleaner including an intake motor and a mop, and the station 20 may be a station to which the corded or cordless cleaner is dockable.

The cleaner 10 may clean a floor while moving across the floor. The floor cleaned by the cleaner 10 may be referred to as a surface to be cleaned (surface being cleaned). The cleaner 10 may perform dry cleaning and/or wet cleaning. The cleaner 10 may draw in (pick up) or wipe away dirt on the surface to be cleaned. Here, the term “dirt” may refer to foreign substances, such as dust, hair, food particles, and the like.

The cleaner 10 may be docked to the station 20. The cleaner 10 docked to the station 20 may include the cleaner 10 seated on and docked at the station 20. At least a portion of the cleaner 10 may be placed in a receiving space 210a of the station 20.

The cleaner 10 may move to the station 20 during cleaning and/or after completion of the cleaning.

For example, the cleaner 10 may move to the station 20 in a case where recharging is required, in a case where dirt in a dust bin requires to be emptied, in a case where a water tank is low on water, in a case where moisture content of a mop 160 is low, in a case where the mop 160 requires to be washed (e.g., cleaned and/or sterilized), and/or in a case where the mop 160 requires to be dried.

The station 20 may be configured such that the cleaner 10 may be docked to the station 20. The station 20 may be configured such that the cleaner 10 may be seated. The station 20 may be configured to store the cleaner 10.

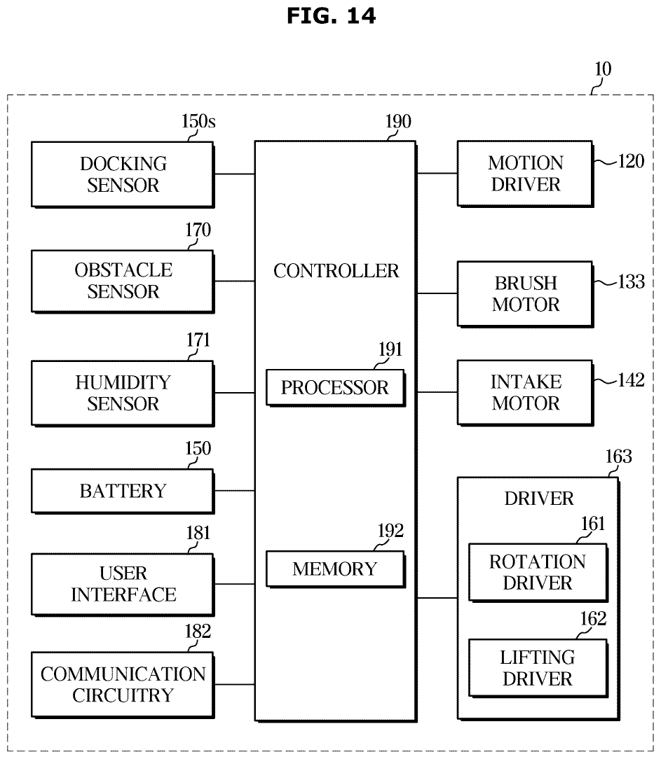

For example, while the cleaner 10 is seated on the station 20, the station 20 may charge a battery 150 (see FIG. 14) of the cleaner 10. For example, while the cleaner 10 is seated on the station 20, the station 20 may collect the dirt collected in the dust bin of the cleaner 10. For example, while the cleaner 10 is seated on the station 20, the station 20 may supply water to the water tank 114 of the cleaner 10. For example, while the cleaner 10 is seated on the station 20, the station 20 may wet the mop 160 with water and/or steam. For example, while the cleaner 10 is seated on the station 20, the station 20 may wash (e.g., clean and/or sterilize) the mop 160. For example, while the cleaner 10 is seated on the station 20, the station 20 may dry the mop 160.

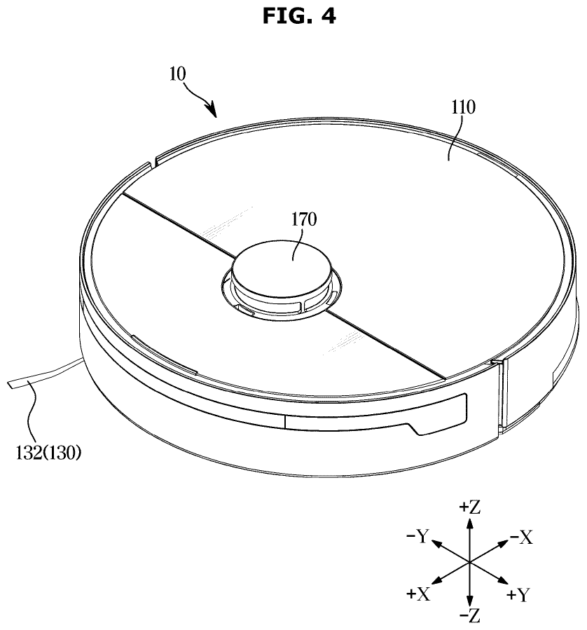

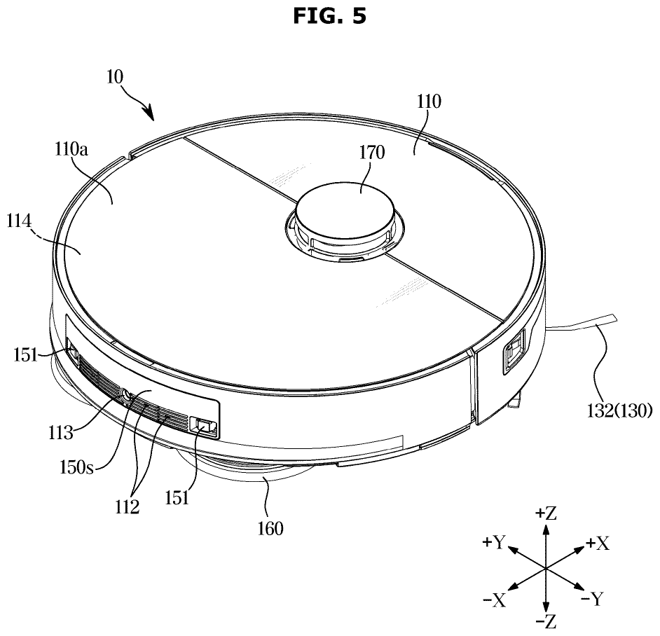

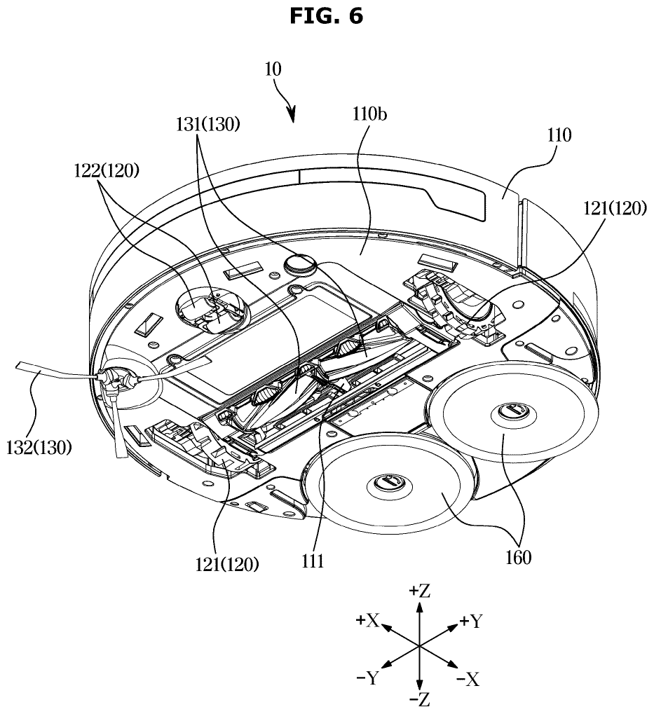

FIG. 4 is a view illustrating a cleaner according to an embodiment. FIG. 5 is a rear view of the cleaner shown in FIG. 4. FIG. 6 is a view illustrating a lower portion of the cleaner shown in FIG. 4.

The cleaner 10 may include a main body 110. The main body 110 may form an overall exterior of the cleaner 10. Components of the cleaner 10 may be accommodated in the main body 110. Electronic components may be disposed in the main body 110. The main body 110 may be referred to as the cleaner main body 110.

The cleaner 10 may include an inlet 111. The inlet 111 may face the surface to be cleaned. The inlet 111 may be open to the surface to be cleaned. The inlet 111 may be formed in the main body 110. The inlet 111 may be formed in a lower portion of the main body 110. The inlet 111 may be formed through a lower surface 110b of the main body 110. Dirt on the surface to be cleaned may be drawn into the main body 110 through the inlet 111 together with air. The inlet 111 may be referred to as the cleaner inlet 111.

The cleaner 10 may include a brush 130. The brush 130 may scatter dirt by scrubbing the surface to be cleaned. Dirt scattered by the brush 130 may flow into the inlet 111 together with air.

For example, the cleaner 10 may include a first brush 131 disposed in the inlet 111. The first brush 131 may be rotatably mounted with respect to the main body 110. A rotation axis of the first brush 131 may be an axis extending along a substantially horizontal direction (Y direction). The first brush 131 may be referred to as the main brush 131.

For example, the cleaner 10 may include a second brush 132 disposed adjacent to a lower edge of the main body 110. The second brush 132 may direct, to the inlet 111, dirt around the main body 110 where the first brush 131 may not sweep. The second brush 132 may be rotatably mounted with respect to the main body 110. A rotation axis of the second brush 132 may be an axis extending along a substantially vertical direction (Z direction). The second brush 132 may be referred to as the side brush 132.

The cleaner 10 may include the dust bin (not shown). Dirt and/or air drawn in through the inlet 111 may move to the dust bin. Dirt drawn in through the inlet 111 may be collected in the dust bin. The air drawn in through the inlet 111 may be filtered while passing through the dust bin. The dirt and air drawn in through the inlet 111 may be separated within the dust bin.

The cleaner 10 may include an outlet 112. The outlet 112 may be formed in the main body 110. The outlet 112 may be formed on a rear side of the main body 110. The air drawn in through the inlet 111 may be filtered and discharged to the outside of the cleaner 10 through the outlet 112. For example, a plurality of outlets 112 may be formed, and the plurality of outlets may be formed as a plurality of holes. The outlet 112 may be referred to as the cleaner outlet 112.

The cleaner 10 may include an intake motor 142 (see FIG. 14). The intake motor 142 may generate suction force. Due to the suction force generated by the intake motor 142, dirt and/or air may be drawn in through the inlet 111. Due to the suction force generated by the intake motor 142, the air drawn into and filtered in the cleaner 10 may be discharged to the outside through the outlet 112. The intake motor 142 may be disposed in an air flow path formed between the inlet 111 and the outlet 112. The intake motor 142 may be referred to as the cleaner intake motor 142.

The cleaner 10 may include a motion driver 120 for moving the cleaner 10. The motion driver 120 is mounted to the main body 110 and may move the main body 110. For example, the motion driver 120 may include a pair of main wheels 121. For example, the motion driver 120 may further include at least one auxiliary wheel 122 to enable the cleaner 10 to travel stably.

The cleaner 10 may include the battery 150 (see FIG. 14). The battery 150 may be rechargeable. The battery 150 may provide power required to drive the cleaner 10.

The cleaner 10 may include a charging terminal 151. The charging terminal 151 may be electrically connected to the battery 150. While the cleaner 10 is seated on the station 20, the charging terminal 151 of the cleaner 10 may be electrically connected to a charging terminal 218 of the station 20. Because the charging terminal 151 of the cleaner 10 may be electrically connected to the charging terminal 218 of the station 20, the battery 150 of the cleaner 10 may be charged. That is, while the cleaner 10 is docked at the station 20, the battery 150 may be charged. The charging terminal 151 may be referred to as the cleaner charging terminal 151.

The cleaner 10 may include the mop 160. The mop 160 is detachably mountable to a lower portion of the main body 110. The mop 160 may be rotatably mounted with respect to the main body 110. The mop 160 may clean the surface to be cleaned by contacting the surface to be cleaned. In a state where the mop 160 is wet, the mop 160 may wipe away dirt on the surface to be cleaned. Although the two mops 160 are illustrated in the drawings, the number of mops 160 is not limited thereto. The mop 160 may be referred to as the cleaning pad 160. The mop 160 may also be referred to as the wet pad 160.

The mop 160 may receive moisture from the water tank 114 of the cleaner 10. The mop 160 may receive moisture from the station 20. For example, in a case where a moisture content of the mop 160 decreases while the cleaner 10 is cleaning, water stored in the water tank 114 may be provided to the mop 160. For example, in a case where the moisture content of the mop 160 decreases while the cleaner 10 is cleaning, the cleaner 10 may return to the station 20 and be seated on the station 20. In this case, the station 20 may supply water to the water tank 114 or spray water and/or steam toward the mop 160. Seating (placing) the cleaner 10 on the station 20 may include docking the cleaner 10 at the station 20.

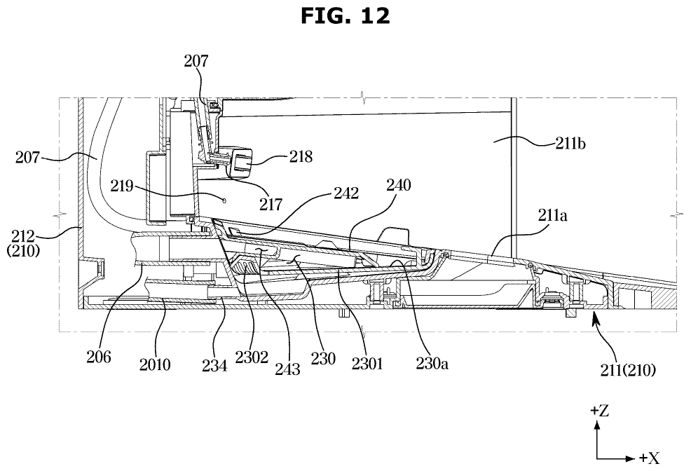

The cleaner 10 may include a water filling portion 113. The water filling portion 113 may be formed in the main body 110. The water filling portion 113 may be formed on the rear side of the main body 110. While the cleaner 10 is seated on the station 20, the water filling portion 113 may receive water from the station 20. The water supplied to the cleaner 10 through the water filling portion 113 may be stored in the water tank 114. While the cleaner 10 is seated on the station 20, the water filling portion 113 of the cleaner 10 may be docked at a first water supply 217 (see FIG. 12) of the station 20, which will be described below.

The cleaner 10 may include a rotation driver 161 (see FIG. 14) that rotates the mop 160. The rotation driver 161 may include a motor. The rotation driver 161 may be referred to as the motor 161. For example, while the cleaner 10 is mounted to (seated on) the station 20 and the mop 160 is washed and/or sterilized, the motor 161 may rotate the mop 160. As will be described below, a controller 190 (see FIG. 14) of the cleaner 10 may control the motor 161 to rotate the mop 160.

The cleaner 10 may include a lifting driver 162 (FIG. 14) that moves the mop 160 up and down. While the cleaner 10 is cleaning, the lifting driver 162 may move the mop 160 downward. As a result, the mop 160 may come into contact with the surface being cleaned. While the cleaner 10 completes cleaning and returns to the station 20, the lifting driver 162 may move the mop 160 upward. As a result, the mop 160 may be spaced apart from the surface to be cleaned. While the cleaner 10 is moving to the station 20, the mop 160 may be prevented from colliding with an obstacle on the surface to be cleaned or from leaving moisture on the surface to be cleaned. As will be described below, the first controller 190 (see FIG. 14) of the cleaner 10 may control the lifting driver 162 to move the mop 160 up and down.

The cleaner 10 may include an obstacle sensor 170. The obstacle sensor 170 may detect a location of an obstacle or a distance to the obstacle. The obstacle sensor 170 may be mounted to the main body 110. For example, the obstacle sensor 170 may protrude from an upper surface 110a of the main body 110.

The cleaner 10 may include a docking sensor 150s. The docking sensor 150s may exchange detection signals (e.g., infrared signals) with a docking sensor 250s of the station 20.

In an embodiment, the docking sensor 150s may include a signal transmitter (e.g., infrared transmitter) and/or a signal receiver (e.g., infrared receiver), and a sensor window for covering the signal transmitter and the signal receiver. The sensor window may refer to a cover through which detection signals may pass.

In an embodiment, the docking sensor 150s may be positioned to face the docking sensor 250s of the station 20 while the cleaner 10 is docked to the station 20.

For example, in a case where the cleaner 10 docks with the station 20 from the front, the docking sensor 150s may be disposed at the front of the cleaner 10, and in a case where the cleaner 10 docks with the station 20 from the rear, the docking sensor 150s may be disposed at the rear of the cleaner 10.

Although not shown in the drawings, the cleaner 10 may further include a front sensor. The front sensor may detect a location of an obstacle in front of the cleaner 10 or a distance to the obstacle. For example, the front sensor may include a radar and/or a camera.

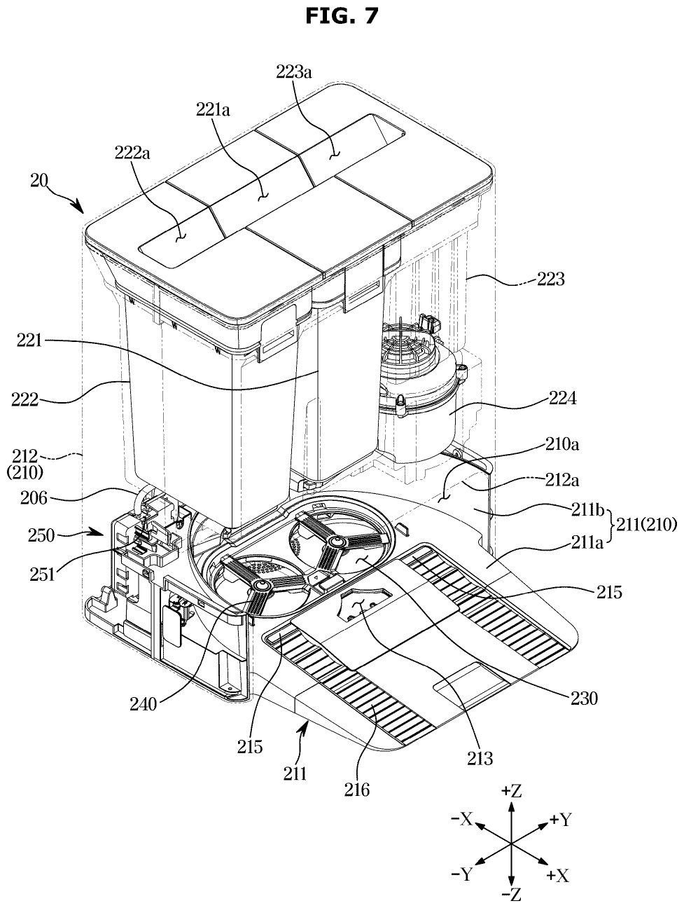

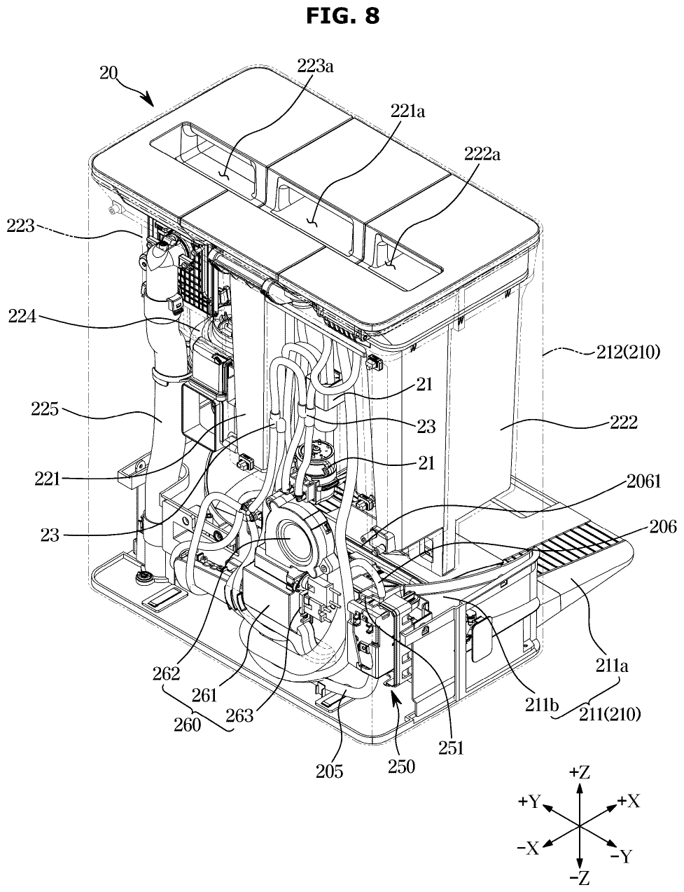

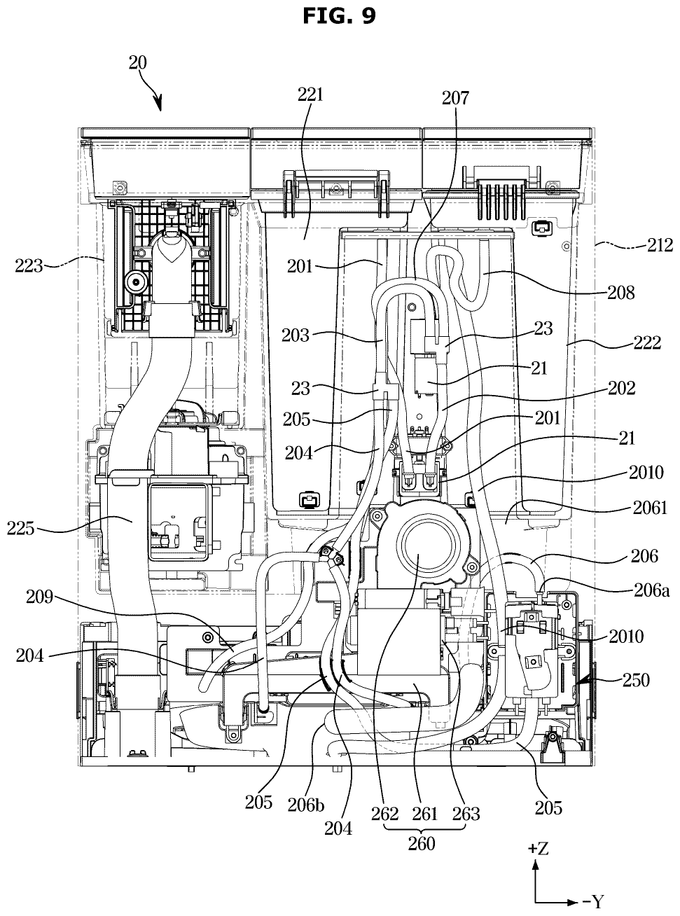

FIG. 7 is a view illustrating a station according to an embodiment. FIG. 8 is a view illustrating a rear portion of the station shown in FIG. 7. FIG. 9 is a view illustrating a rear surface of the station shown in FIG. 7.

The station 20 may include a main body 210. The main body 210 may form an overall exterior of the station 20. The main body 210 may form the receiving space 210a to receive at least a portion of the cleaner 10. The main body 210 may be referred to as the station main body 210.

The main body 210 may include a base 211 and a housing 212 that may be detachably coupled to the base 211.

The base 211 may include a cleaner seating portion 211a on which the cleaner 10 is seated (placed). The cleaner seating portion 211a may be inclined from a surface to be cleaned to allow the cleaner 10 to enter. For example, the cleaner seating portion 211a may be inclined upward along a direction in which the cleaner 10 enters the station 20. For example, an anti-slip portion 216 may be formed on the cleaner seating portion 211a to allow the cleaner 10 to easily climb the inclined surface of the cleaner seating portion 211a. For example, an anti-slip bump 215 may be formed on the cleaner seating portion 211a to prevent the cleaner 10 seated on the station 20 from slipping along the inclined surface of the cleaner seating portion 211a. The cleaner 10 seated on the station 20 may not be separated from the station 20 by the anti-slip bump 215.

The base 211 may include a side wall portion 211b extending upward from the cleaner seating portion 211a. The side wall portion 211b may surround at least a portion of the cleaner seating portion 211a.

The housing 212 may cover the side wall portion 211b of the base 211. The housing 212 may accommodate components of the station 20. Electronic components may be disposed in the housing 212. The housing 212 may have an opening 212a, and the cleaner 10 may enter the receiving space 210a of the station 20 through the opening 212a.

The station 20 may include a water storage container 221. The water storage container 221 may store water. Relatively clean water may be stored in the water storage container 221. The water stored in the water storage container 221 may be provided to the water tank 114 of the cleaner 10 or to a washing chamber 230 of the station 20, which will be described below. That is, the water stored in the water storage container 221 may be used to wet the mop 160 or to wash the mop 160. The water storage container 221 is detachably mountable to the main body 210. For example, a user may separate the water storage container 221 from the main body 210 or couple the water storage container 221 to the main body 210 by holding a handle 221a of the water storage container 221.

The station 20 may include a wastewater container 222. The wastewater container 222 may store water. Relatively dirty water may be stored in the wastewater container 222. The dirty water (wastewater) generated by washing the mop 160 may be stored in the wastewater container 222. The wastewater container 222 is detachably mountable to the main body 210. For example, a user may separate the wastewater container 222 from the main body 210 or couple the wastewater container 222 to the main body 210 by holding a handle 222a of the wastewater container 222.

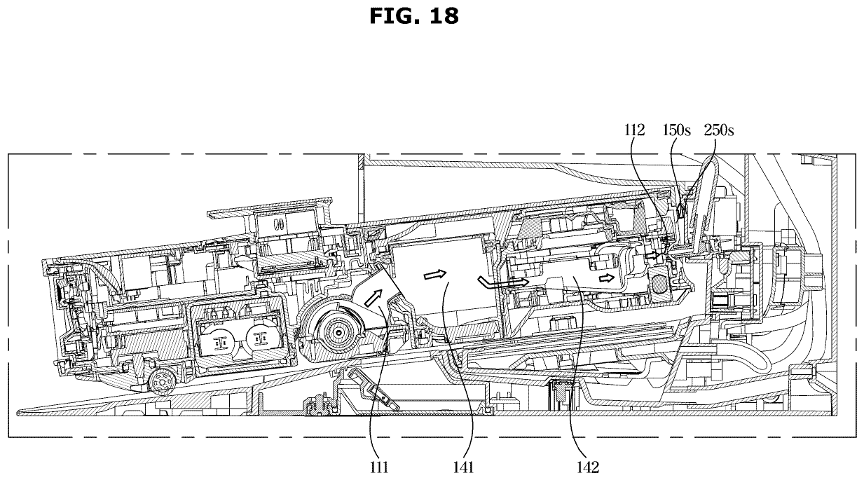

The station 20 may include a dirt container 223. The dirt container 223 may store dirt collected from the dust bin (see 141 in FIG. 18) of the cleaner 10. The dirt container 223 is detachably mountable to the main body 210. For example, a user may separate the dirt container 223 from the main body 210 or couple the dirt container 223 to the main body 210 by holding a handle 223a of the dirt container 223.

Although the wastewater container 222, the water storage container 221, and the dirt container 223 are shown as being arranged side by side along the approximately horizontal direction (Y direction), a position of each of the wastewater container 222, the water storage container 221, and the dirt container 223 is not limited thereto.

The station 20 may include an inlet 213. The inlet 213 may be formed in the cleaner seating portion 211a. While the cleaner 10 is seated on the station 20, the inlet 213 may communicate with the dust bin of the cleaner 10. The dirt collected in the dust bin may be drawn in through the inlet 213. The inlet 213 may be referred to as the station inlet 213.

The station 20 may include a dirt collection duct 225. The dirt collection duct 225 may guide the dirt drawn in through the inlet 213 to the dirt container 223. The dirt collection duct 225 may be disposed between the inlet 213 and the dirt container 223. One end of the dirt collection duct 225 may communicate with the inlet 213. The other end of the dirt collection duct 225 may communicate with the dirt container 223.

The station 20 may include an outlet 214 (see FIG. 3). The outlet 214 may be formed on a rear side of the main body 210. The outlet 214 may be formed at a rear side of the housing 212. The air drawn into and filtered in the station 20 may be discharged to the outside through the outlet 214. For example, a plurality of outlets 214 may be formed, and the plurality of outlets 214 may be formed as a plurality of holes. The outlet 214 may be referred to as the station outlet 214.

The station 20 may include an intake motor 224. When the cleaner 10 is seated on the station 20, the intake motor 224 may generate suction force to draw dirt from the dust bin. Due to the suction force of the intake motor 224, the dirt in the dust bin may flow along the inlet 112 and the dirt collection duct 225 and may be collected in the dirt container 223. Due to the suction force generated by the intake motor 224, the air drawn into the station 20 and passed through an exhaust filter 226 may be discharged to the outside through the outlet 214. The intake motor 224 may be referred to as the station intake motor 224.

The station 20 may include a heating device 250. The heating device 250 may heat the water stored in the water storage container 221 and supply the heated water to the washing chamber 230 to be described below.

That is, the heating device 250 may heat the water stored in the water storage container 221 and supply the heated water to the washing chamber 230.

In an embodiment, the heating device 250 may generate steam (hot water). The heating device 250 may generate steam using the water stored in the water storage container 221. The heating device 250 may generate steam by receiving water stored in the water storage container 221.

The heating device 250 may also be referred to as a steam device in that steam is supplied to the washing chamber 230 by heating the water supplied from the water storage container 221.

The heating device 250 may be disposed below the water storage container 221. In supplying water from the water storage container 221 to the heating device 250, at least one pump 21 may pump the water from the water storage container 221 even with relatively low power by gravity.

The heating device 250 may include a steam container 251 that may accommodate water delivered from the water storage container 221.

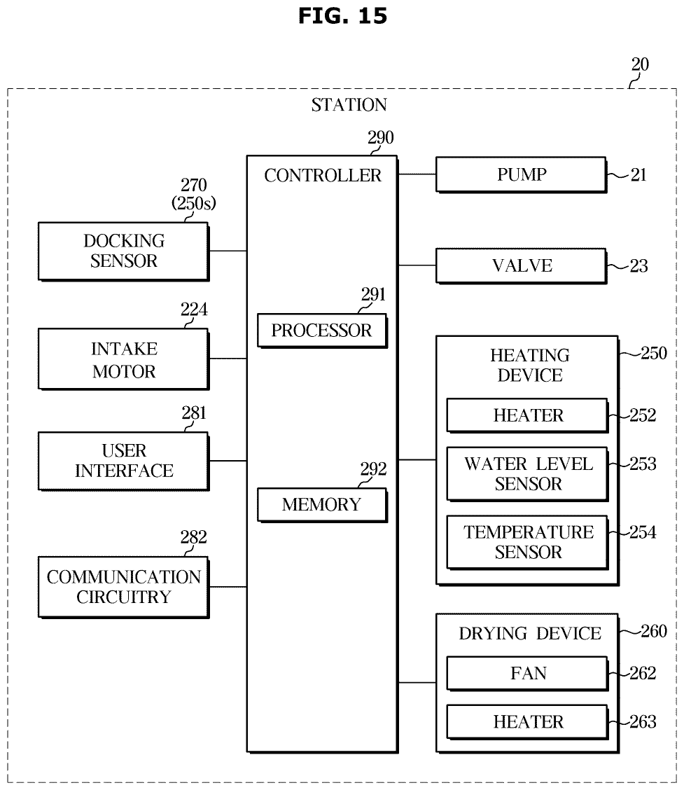

The heating device 250 may include a heater 252 to heat water in the steam container 251. Steam may be generated as the water in the steam container 251 is heated by the heater 252. As will be described below, a controller 290 (see FIG. 15) of the station 20 may control the heater 252.

For example, the heater 252 may heat water using vibration and/or electrical resistance. However, the disclosure is not limited to the above-described example, and the type of heater 252 is not limited as long as it may generate steam by heating water.

The heating device 250 may include a water level sensor 253 (see FIG. 15) to detect a water level in the steam container 251. The controller 290 (see FIG. 15) of the station 20 may operate the heater 252 based on a predetermined water level being detected by the water level sensor 253. Detecting the predetermined water level by the water level sensor 253 may include detecting that the water level in the steam container 251 reaches the predetermined water level by the water level sensor 253.

As a result, the heater 252 may operate only when the steam container 251 is filled with a predetermined amount of water or more, thereby preventing accidents such as fire.

The heating device 250 may include a temperature sensor 254 (FIG. 15) to detect a temperature in the steam container 251. As will be described below, the controller 290 (see FIG. 15) of the station 20 may stop an operation of the heater 252 based on the temperature detected by the temperature sensor 254 being higher than a predetermined temperature. As a result, in a case where a steam temperature is extremely high, the operation of the heater may be stopped, preventing accidents such as fires in advance and preventing damage to the cleaning system (e.g., a mop).

The station 20 may include at least one pipe 201, 202, 203, 204, 205, 206, 207, 208, 209 and 2010. The station 20 may include at least one pump 21. The station 20 may include at least one valve 23.

The station 20 may include a first pipe 201. The first pipe 201 may connect the water storage container 221 and the pump 21. One end of the first pipe 201 may communicate with the water storage container 221. The other end of the first pipe 201 may communicate with the pump 21. The first pipe 201 may guide water flowing from the water storage container 221 or water flowing from the pump 21. Water may flow along a first flow path formed inside the first pipe 201.

The station 20 may include a second pipe 202. The second pipe 202 may connect the pump 21 and the valve 23. One end of the second pipe 202 may communicate with the pump 21. The other end of the second pipe 202 may communicate with the valve 23. The second pipe 202 may allow water pumped by the pump 21 to flow. The second pipe 202 may guide water flowing from the pump 21 or water flowing from the valve 23. Water may flow along a second flow path formed inside the second pipe 202.

The station 20 may include a third pipe 203. The third pipe 203 may be disposed between the pump 21 and the valve 23. The third pipe 203 may be disposed between two valves 23. One end of the third pipe 203 may communicate with the one valve 23. The other end of the third pipe 203 may communicate with the other valve 23. The third pipe 203 may allow water pumped by the pump 21 to flow. The third pipe 203 may guide water flowing from the valve 23 or the water flowing from the valve 23. Water may flow along a third flow path formed inside the third pipe 203.

The station 20 may include a fourth pipe 204. The fourth pipe 204 may connect the valve 23 and the base 211. The fourth pipe 204 may connect the valve 23 and a second water supply 231. One end of the fourth pipe 204 may communicate with the valve 23. The other end of the fourth pipe 204 may communicate with the second water supply 231. The other end of the fourth pipe 204 may communicate with the washing chamber 230. The fourth pipe 204 may guide water flowing from the valve 23. The fourth pipe 204 may guide the water pumped by the pump 21 to the washing chamber 230. Water may flow along a fourth flow path formed inside the fourth pipe 204.

The station 20 may include a fifth pipe 205. The fifth pipe 205 may connect the valve 23 and the heating device 250. One end of the fifth pipe 205 may communicate with the valve 23. The other end of the fifth pipe 205 may communicate with the heating device 250. The fifth pipe 205 may guide water flowing from the valve 23 or water flowing from the heating device 250. The fifth pipe 205 may guide the water pumped by the pump 21 to the heating device 250. Accordingly, the water stored in the water storage container 221 may be guided by the fifth pipe 205 and flow to the heating device 250. Alternatively, the fifth pipe 205 may guide the water pumped by the pump 21 to the valve 23. Accordingly, the water stored in the heating device 250 may be guided by the fifth pipe 205 and flow to the valve 23. Water may flow along a fifth flow path formed inside the fifth pipe 205.

For example, the fifth pipe 205 may be connected to a lower portion of the heating device 250. Water may be filled from a lower portion of the steam container 251 of the heating device 250.

The station 20 may include a sixth pipe 206. The sixth pipe 206 may connect the heating device 250 and the base 211. The sixth pipe 206 may connect the heating device 250 and a steam supply 233. One end 206a (see FIG. 9) of the sixth pipe 206 may communicate with the heating device 250. The other end 206b (see FIG. 9) of the sixth pipe 206 may communicate with the steam supply 233. The other end 206b of the sixth pipe 206 may communicate with the washing chamber 230. The sixth pipe 206 may guide steam generated by the heating device 250. The sixth pipe 206 may guide the steam generated by the heating device 250 to the washing chamber 230. Steam may flow along a sixth flow path formed inside the sixth pipe 206.

For example, the sixth pipe 206 may be connected to an upper portion of the heating device 250. Considering that a density of steam is generally lower than that of air and steam moves upward, the sixth pipe 206 may be connected to the upper portion of the heating device 250.

For example, the sixth pipe 206 may include a bending portion 2061 (see FIG. 9) that is bent at a height between the heating device 250 and the water storage container 221. Accordingly, water and/or dirt in the washing chamber 230 may be prevented from flowing back into the heating device 250.

The station 20 may include a seventh pipe 207. The seventh pipe 207 may connect the valve 23 and the base 211. The seventh pipe 207 may connect the valve 23 and the first water supply 217. One end of the seventh pipe 207 may communicate with the valve 23. The other end of the seventh pipe 207 may communicate with the first water supply 217. The seventh pipe 207 may guide water flowing from the valve 23. The seventh pipe 207 may guide water flowing from the second pipe 202 to the cleaner 10 seated on the station 20. Water may flow along a seventh flow path formed inside the seventh pipe 207.

The station 20 may include an eighth pipe 208. The eighth pipe 208 may connect the wastewater container 222 and the pump 21. One end of the eighth pipe 208 may communicate with the wastewater container 222. The other end of the eighth pipe 208 may communicate with the pump 21. The eighth pipe 208 may guide air flowing from the wastewater container 222. Air may flow along an eighth flow path formed inside the eighth pipe 208.

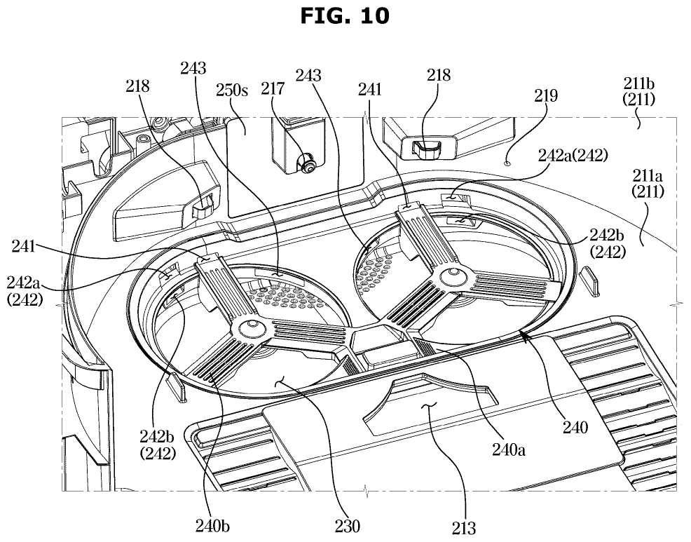

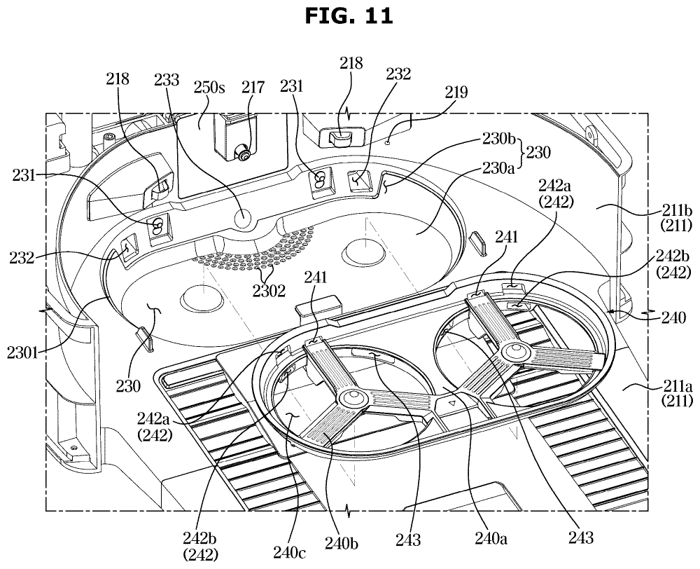

The station 20 may include a ninth pipe 209. The ninth pipe 209 may connect the pump 21 and the base 211. The ninth pipe 209 may connect the pump 21 and an air discharge hole 219 (see FIG. 10, FIG. 11 and FIG. 12). One end of the ninth pipe 209 may communicate with the pump 21. The other end of the ninth pipe 209 may communicate with the outside through the air discharge hole 219. The ninth pipe 209 may guide air pumped by the pump 21. Air may flow along a ninth flow path formed inside the ninth pipe 209.

The station 20 may include a tenth pipe 2010. The tenth pipe 2010 may connect the wastewater container 222 and the base 211. The tenth pipe 2010 may connect the wastewater container 222 and a wastewater collection portion 234. One end of the tenth pipe 2010 may communicate with the wastewater container 222. The other end of the tenth pipe 2010 may communicate with the wastewater collection portion 234. The other end of the tenth pipe 2010 may communicate with the washing chamber 230. The tenth pipe 2010 may guide wastewater in the washing chamber 230. Wastewater may flow along a tenth flow path formed inside the tenth pipe 2010.

The station 20 may include the dirt collection duct 225. The dirt collection duct 225 may connect the dirt container 223 and the base 211.

The station 20 may include a drying duct 261. The drying duct 261 may guide dry air. The drying duct 261 may guide air, blown by a fan 262 and heated by a heater 263, to the base 211.

The station 20 may include the at least one pump 21. The pump 21 may be connected to the water storage container 221. The pump 21 may be connected to the wastewater container 222. The pump 21 may be connected to the water storage container 221 via the first pipe 201. The pump 21 may be connected to the wastewater container 222 via the eighth pipe 208. The pump 21 may be connected with the valve 23. The pump 21 may be connected with the air discharge hole 219. The pump 21 may be connected to the valve 23 via the second pipe 202. The pump 21 may be connected to the air discharge hole 219 via the ninth pipe 209. The pump 21 may be disposed between the water storage container 221 and the valve 23. The pump 21 may be disposed between the waste wastewater container 222 and the base 211.

The pump 21 may pump water stored in the water storage container 221. The pump 21 may pump air from the wastewater container 222. The pump 21 may pump water accommodated in the heating device 250.

For example, power to flow water may be generated while internal components (e.g., piston, rotor, or impeller) of the pump 21 rotate. For example, while the internal components of the pump 21 rotate in a first direction, the pump 21 may pump the water stored in the water storage container 221 (see FIG. 18), and while the internal components of the pump 21 rotate in a second direction which is opposite to the first direction, the pump 21 may pump the water in the heating device 250.

The station 20 may include the at least one valve 23. The valve 23 may be connected to the second pipe 202. The valve 23 may be connected to the third pipe 203. The valve 23 may be connected to the fourth pipe 204. The valve 23 may be connected to the fifth pipe 205. The valve 23 may be connected to the seventh pipe 207.

The valve 23 may allow communication between the second pipe 202 and the seventh pipe 207 or communication between the second pipe 202 and the third pipe 203. The valve 23 may adjust a flow of water pumped by the pump 21. The valve 23 may allow the water pumped by the pump 21 to flow to the first water supply 217 or the valve 23. For example, the valve 23 may selectively open the seventh pipe 207 and the third pipe 203.

The valve 23 may allow communication between the third pipe 203 and the fourth pipe 204 or communication between the third pipe 203 and the fifth pipe 205. The valve 23 may adjust a flow of water guided by the third pipe 203. The valve 23 may allow the water guided by the third pipe 203 to flow to the second water supply 231 or the heating device 250. For example, the valve 23 may selectively open the fourth pipe 204 and the fifth pipe 205.

The station 20 may include a drying device 260. The drying device 260 may generate air for drying the mop 160 (hereinafter referred to as “dry air”). The drying device 260 may provide dry air to the washing chamber 230 to be described below. That is, the drying device 260 may blow dry air to the washing chamber 230.

While the cleaner 10 is seated on the station 20, dry air discharged from the drying device 260 may be directed to the mop 160 accommodated in the washing chamber 230 and/or to the outside of the washing chamber 230.

The air (dry air) generated and provided by the drying device 260 may have relatively low humidity or high temperature. The dry air may also be referred to as hot air or dry wind.

For example, after washing and/or sterilizing the mop 160, the station 20 may provide dry air to the mop 160. For example, in a case where a moisture content of the mop 160 increases as the mop 160 wipes water from the surface to be cleaned during cleaning, the cleaner 10 may return to the station 20 and the station 20 may discharge dry air to the mop 160.

The drying device 260 may include the fan 262 that generates blowing force. The drying device 260 may include the drying duct 261 to guide air blown by the fan 262. The drying duct 261 may connect the fan 262 and the washing chamber 230 to be described below. The drying device 260 may include the heater 263 to heat the air blown by the fan 262. The heater 263 may heat the air guided by the drying duct 261. At least a portion of the heater 263 may be disposed in the drying duct 261.

FIG. 10 is a view illustrating a portion of a station according to an embodiment. FIG. 11 illustrates a state in which a washing frame is separated from a washing chamber in a station according to an embodiment. FIG. 12 is a side cross-sectional view of a station based on a heating device according to an embodiment.

The station 20 may include the washing chamber 230. While the cleaner 10 is docked to the station 20, the washing chamber 230 may correspond to the mop 160. The washing chamber 230 may be defined as a space where the mop 160 is washed. The washing chamber 230 may receive water from the water storage container 221. The washing chamber 230 may have a shape to accommodate water. While the cleaner 10 is seated on the station 20, the mop 160 may be washed with the water accommodated in the washing chamber 230.

The washing chamber 230 may be formed in the base 211 of the main body 210. The washing chamber 230 may be recessed from the cleaner seating portion 211a. The washing chamber 230 may be defined by a chamber bottom 230a and a chamber side wall 230b extending upward from the chamber bottom 230a. The chamber side wall 230b may have a predetermined height.

The chamber bottom 230a may be inclined downward along a direction in which the cleaner 10 enters the station 20. For example, the chamber bottom 230a may be inclined downwardly toward the rear. Accordingly, after washing of the mop 160 is completed, the water (wastewater) in the washing chamber 230 may easily flow to the wastewater collection portion 234 located at the rear of the washing chamber 230 along the inclined surface of the chamber bottom 230a. However, the disclosure is not limited thereto, and an inclination direction of the chamber bottom 230a may vary depending on a location of the wastewater collection portion 234.

For example, the station 20 may include a tray 2301. The tray 2301 is detachably mountable to the base 211 of the main body 210 to form at least a portion of the washing chamber 230. For example, the tray 2301 may form at least a portion of the chamber bottom 230a and the chamber side wall 230b. The tray 2301 may include at least one tray hole 2302. The wastewater in the washing chamber 230 may pass through the tray hole 2302 and flow into the wastewater collection portion 234. Because the tray 2301 includes the tray hole 2302, foreign substances larger than the tray hole 2302 may be filtered into the tray 2301. That is, the tray 2301 may first filter the wastewater after washing the mop 160.

The station 20 may include a washing frame 240. The washing frame 240 may correspond to the washing chamber 230. The washing frame 240 is detachably mountable to the washing chamber 230. While the cleaner 10 is docked to the station 20, the washing frame 240 may contact the mop 160. While the cleaner 10 is docked to the station 20, the washing frame 240 may be rubbed (scrubbed) against the mop 160. The mop 160 may be washed by rubbing against the washing frame 240. In this instance, the mop 160 may be rotatable.

As will be described below, in a case where the mop 160 moves to a first position while the cleaner 10 is docked to the station 20, the mop 160 may be seated on the washing frame 240.

The washing frame 240 may include a frame body 240a, a frame protrusion 240b, and a frame opening 240c. The frame body 240a may be detachably coupled to the chamber side wall 230b. The frame opening 240c may be formed through the frame body 240a. The frame protrusion 240b may be formed on the frame body 240a to interfere with the mop 160.

The frame body 240a may include a dry air discharge opening 242, and the dry air discharge opening 242 may be divided into an upper discharge opening 242a and a lower discharge opening 242b based on a plate including the frame protrusion 240b.

While the mop 160 is seated on the washing frame 240, the mop 160 may close the frame opening 240c. When the mop 160 closes the frame opening 240c, the washing chamber 230 may be defined by the chamber bottom 230a, the frame body 240a, and the chamber side wall 230b.

The station 20 may include the docking sensor 250s. The docking sensor 250s may include a signal transmitter (e.g., an infrared transmitter) and/or a signal receiver (e.g., an infrared receiver), and a sensor window for covering the signal transmitter and the signal receiver. The sensor window may refer to a cover through which detection signals may pass.

The docking sensor 250s may be positioned to face the docking sensor 150s of the cleaner 10 while the cleaner 10 is docked to the station 20.

The docking sensor 250s may determine whether the cleaner 10 is docked to the station 20 by transmitting and receiving a signal with the docking sensor 150s of the cleaner 10. The docking sensor 250s may assist in placing the cleaner 10 by transmitting and receiving a signal with the docking sensor 150s of the cleaner 10.

The station 20 may include the charging terminal 218. While the cleaner 10 is seated on the station 20, the charging terminal 218 of the station 20 may be electrically connected to the charging terminal 151 of the cleaner 10. Because the charging terminal 218 of the station 20 and the charging terminal 151 of the cleaner 10 are electrically connected, the battery 150 of the cleaner 10 may be charged. That is, the cleaner 10 may be charged while docked at the station 20. The charging terminal 218 may be referred to as the station charging terminal 218.

The station 20 may include the first water supply 217. The first water supply 217 may receive water from the water storage container 221 and supply the water to the cleaner 10. While the cleaner 10 is docked to the station 20, the first water supply 217 of the station 20 may be connected to the water filling portion 113 of the cleaner 10. The water discharged from the first water supply 217 may flow into the water filling portion 113. The water introduced through the water filling portion 113 may be stored in the water tank 114. In a case where a moisture content of the mop 160 decreases during cleaning of the cleaner 10, the water stored in the water tank 114 may be provided to the mop 160. For example, the first water supply 217 may be formed on the side wall 211b of the base 211 of the main body 210.

The station 20 may include the second water supply 231. The second water supply 231 may communicate with the washing chamber 230. The second water supply 231 may receive water from the water storage container 221 and supply the water to the washing chamber 230. The water discharged from the second water supply 231 may be accommodated in the washing chamber 230. The water discharged from the second water supply 231 may be used to wash the mop 160. Although two second water supplies 231 are shown in the drawings, the number of second water supplies 231 is not limited. For example, the number of second water supplies 231 may be equal to the number of mops 160.

The station 20 may include a water discharge opening 241. The water discharge opening 241 may be formed in the washing frame 240. While the washing frame 240 is mounted to the washing chamber 230, the water discharge opening 241 may correspond to the second water supply 231. The water discharge opening 241 may communicate with the second water supply 231. The water discharge opening 241 may communicate with the washing chamber 230. The water discharge opening 241 may receive water from the second water supply 231 and spray the water to the washing chamber 230. While the cleaner 10 is docked to the station 20, the water discharge opening 241 may spray water toward the mop 160. Although two water discharge openings 241 are shown in the drawings, the number of water discharge openings 241 is not limited. For example, the number of water discharge openings 241 may be equal to the number of mops 160.

The station 20 may include a dry air supply 232. The dry air supply 232 may communicate with the washing chamber 230. The dry air supply 232 may receive dry air from the drying device 260 and supply the dry air to the washing chamber 230. The dry air discharged from the drying device 260 may be supplied to the washing chamber 230 through the dry air supply 232. Although two dry air supplies 232 are shown in the drawings, the number of dry air supplies 232 is not limited. For example, the number of dry air supplies 232 may be equal to the number of mops 160.

The station 20 may include the dry air discharge opening 242. The dry air discharge opening 242 may be formed in the washing frame 240. While the washing frame 240 is mounted to the washing chamber 230, the dry air discharge opening 242 may correspond to the dry air supply 232. The dry air discharge opening 242 may communicate with the dry air supply 232. The dry air discharge opening 242 may communicate with the washing chamber 230. The dry air discharge opening 242 may receive dry air from the dry air supply 232 and spray the dry air to the washing chamber 230. While the cleaner 10 is docked to the station 20, the dry air discharge opening 242 may spray dry air toward the mop 160. Although two vertically arranged dry air discharge openings 242 are shown as corresponding to a single dry air supply 232 in the drawings, the disclosure is not limited thereto. A shape and/or location of the dry air discharge opening 242 is not limited.

The station 20 may include the steam supply 233. The steam supply 233 may communicate with the washing chamber 230. The steam supply 233 may receive steam from the heating device 250 and supply the steam to the washing chamber 230. The steam generated by the heating device 250 may flow to the washing chamber 230 through the steam supply 233. Although only one steam supply 233 is shown in the drawings, the number of steam supplies 233 is not limited. For example, a plurality of steam supplies 233 may be provided.

The station 20 may include a steam discharge opening 243. The steam discharge opening 243 may be formed in the washing frame 240. While the washing frame 240 is mounted to the washing chamber 230, the steam discharge opening 243 may correspond to the steam supply 233. The steam discharge opening 243 may communicate with the steam supply 233. The steam discharge opening 243 may communicate with the washing chamber 230. The steam discharge opening 243 may receive steam from the steam supply 233 and spray the steam to the washing chamber 230. While the cleaner 10 is docked to the station 20, the steam discharge opening 243 may spray steam toward the mop 160. Although two steam discharge openings 243 are shown in the drawings, the number of steam discharge openings 243 is not limited. For example, the number of steam discharge openings 243 may be equal to the number of mops 160.

The station 20 may include the wastewater collection portion 234. The wastewater collection portion 234 may communicate with the washing chamber 230. The wastewater collection portion 234 may collect wastewater in the washing chamber 230. The wastewater collection portion 234 may guide the wastewater in the washing chamber 230.

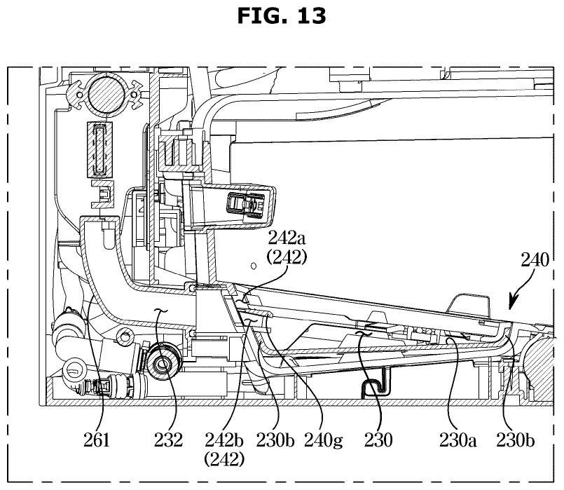

FIG. 13 is a side cross-sectional view of a station based on a drying device according to an embodiment.

Referring to FIG. 13, the drying duct 261 may be connected to the washing chamber 230.

Operation (driving) of the drying device 150 may allow air to be supplied to the washing chamber 230 through the dry air supply 232.

The dry air supply 232 may include a flow path of air supplied to the washing chamber 230 by the drying device 150.

The washing frame 240 may include the dry air discharge opening 242.

The dry air discharge opening 242 may divide the flow path of air supplied to the washing chamber 230 into at least two flow paths.

While the washing frame 240 is mounted to the washing chamber 230, the dry air supply 232 may be divided into a first flow path 242a and a second flow path 242b by the washing frame 240.

The washing frame 240 may include a guide member 240g to divide the dry air supply 232 into the first flow path 242a and the second flow path 242b.

The guide member 240g may correspond to the frame body 240a of the washing frame 240.

Air flowing through the drying duct 261 by the operation of the drying device 260 may flow to the washing chamber 230 through the first flow path 242a and the second flow path 242b.

When the cleaner 10 is seated on the station 20, the mop 160 is received in the washing chamber 230, and air is supplied to the washing chamber 230 through the first flow path 242a and the second flow path 242b due to the operation of the drying device 260, thereby drying the mop 160.

FIG. 14 is a control block diagram of a cleaner according to an embodiment.

Referring to FIG. 14, the cleaner 10 according to an embodiment may include the docking sensor 150s, the obstacle sensor 170, a humidity sensor 171, the battery 150, a user interface 181, the motion driver 120, a brush motor 133, the intake motor 142, a driver 163, communication circuitry 182 and/or the controller 190.

Hereinafter, for convenience of description, the controller 190 of the cleaner 10 is referred to as the first controller 190.

The docking sensor 150s may communicate with the docking sensor 250s of the station 20 in a non-contact manner using electromagnetic waves such as infrared rays, visible ray, or ultrasonic waves. The docking sensor 150s may be disposed at the rear of the main body 110, and when the cleaner 10 docks with the station 20, the docking sensor 150s may exchange electromagnetic waves (e.g., infrared) with the docking sensor 250s of the station 20.

The docking sensor 150s may irradiate infrared rays and then detect the infrared rays reflected from the docking sensor 250s, and may output, to the first controller 190, an intensity of the detected infrared rays or a time of flight (TOF) from the irradiation of the infrared rays to the detection of the reflected infrared rays.

The docking sensor 150s may detect infrared rays irradiated from the docking sensor 250s of the station 20, and may output, to the first controller 190, an intensity of the detected infrared rays, or time of flight (TOF) from the irradiation of the infrared rays to the detection of the reflected infrared rays.

The first controller 190 may control the motion driver 120 based on data collected from the docking sensor 150s in a case where the cleaner 10 requires to be docked to the station 20.

The obstacle sensor 170 may detect obstacles that impede movement of the cleaner 10. An obstacle may refer to any object that interferes with the movement of the cleaner 10 on or around a floor of a cleaning area. For example, in addition to the presence or absence of a table, sofa, and the like, located in the cleaning area, walls that divide a space may be obstacles, and objects that the cleaner 10 may climb or descend, such as a threshold or a round bar, may also be obstacles.

Specifically, the obstacle sensor 170 may detect obstacles in a non-contact manner using electromagnetic waves such as infrared rays, visible ray, or ultrasonic waves. For example, the obstacle sensor 170 may irradiate infrared rays and then detect the infrared rays reflected from an obstacle, and may output, to the first controller 190, an intensity of the detected infrared rays or a time of flight (TOF) from the irradiation of the infrared rays to the detection of the reflected infrared rays.

The first controller 190 may calculate the presence or absence of an obstacle, or a distance between the obstacle and the cleaner 10 based on an output value of the obstacle sensor 170.

In another example, the obstacle sensor 170 may include an emitter that emits electromagnetic waves and a receiver that receives the electromagnetic waves reflected from the obstacle.

The emitter may be disposed on the front of the main body 110 and transmit electromagnetic waves toward the front of the main body 110. In addition, depending on the embodiment, the emitter may include a light emitting diode (LED) that generates electromagnetic waves and a wide-angle lens that disperses the electromagnetic waves in all directions by refracting the transmitted electromagnetic waves.

In another example, the obstacle sensor 170 may include a camera that obtains images around the cleaner 10 (e.g., in front, behind, and/or side).

The first controller 190 may calculate the presence or absence of an obstacle or the distance between the obstacle and the cleaner 10 based on the image obtained by the obstacle sensor 170.

The humidity sensor 171 may include at least one sensor for measuring a humidity (or moisture content) of the mop 160.

In an embodiment, the humidity sensor 171 may measure a change in moisture in the air. The humidity sensor 171 may be located around the mop 160 to measure the humidity (or moisture content) of the mop 160. In this case, an output humidity of the humidity sensor 171 may be proportional to the moisture content of the mop 160.

The first controller 190 may determine the humidity (or moisture content) of the mop 160 based on the humidity measured by the humidity sensor 171.

In an embodiment, the humidity sensor 171 may irradiate light such as infrared rays and visible rays, or electromagnetic waves such as ultrasonic waves to the mop 160, and then may measure an intensity of the electromagnetic waves reflected from the mop 160 and/or a time of flight (TOF) from the irradiation of the electromagnetic waves to the detection of the reflected electromagnetic waves.

For example, the humidity sensor 171 may include a light emitter that irradiates light to the mop 160 and a light receiver that receives light reflected from the mop 160.

The first controller 190 may determine the humidity (or moisture content) of the mop 160 based on an output value of the humidity sensor 171.

The first controller 190 may perform various operations depending on the humidity (or moisture content) of the mop 160. For example, the first controller 190 may control the motion driver 120 to allow the cleaner 10 to return to the station 20 based on the humidity of the mop 160 being measured to be greater than or equal to a predetermined maximum humidity. In another example, the first controller 190 may control the motion driver 120 to allow the cleaner 10 to return to the station 20 based on the humidity of the mop 160 being measured to be less than or equal to a predetermined minimum humidity.

The battery 150 may supply power to various electronic components of the cleaner 10. The battery 150 may be charged while the cleaner 10 is seated on the station 20.

The cleaner 10 may include a battery sensor that detects a charge level of the battery 150.

The first controller 190 may control the motion driver 120 to allow the cleaner 10 to return to the station 20 in response to the charge level of the battery 150 falling below a predetermined charge level.

The user interface 181 may include an output interface and an input interface.

At least one output interface may generate sensory information and transmit various information related to operations of the cleaner 10 to a user.

For example, the at least one output interface may transmit information related to the settings and an operation time of the cleaner 10 to the user. Information about the operation of the cleaner 10 may be output through a display, indicator, and/or may be output as voice. The at least one output interface may include, for example, a liquid crystal display (LCD) panel, an indicator, a light emitting diode (LED) panel, a speaker, and the like.

In a case where the display includes a touch screen display, the touch screen display may correspond to an example of the output interface and the input interface.

In an embodiment, the at least one output interface may output sensory information (e.g., visual information, auditory information, etc.) related to control of the cleaner 10.

At least one input interface may convert the sensory information received from the user into an electrical signal.

The at least one input interface may include a power button for turning on the cleaner 10.

Each button may include a visual indicator (e.g. text, icon, etc.) that may indicate its function.

The at least one input interface may include, for example, a tact switch, a push switch, a slide switch, a toggle switch, a micro switch, a touch switch, a touch pad, a touch screen, a jog dial, and/or a microphone, and the like.

In the disclosure, a “button” may be replaced by a user interface element (UI element), a tact switch, a push switch, a slide switch, a toggle switch, a micro switch, a touch switch, a touch pad, a touch screen, a jog dial, and/or a microphone, and the like.

The cleaner 10 may process a user input received via the user interface 181 and may output information related to the cleaner 10 via the user interface 181.

In an embodiment, the user interface 181 may include an input interface for receiving a mop wash command and/or a mop steam command.

When a user determines that the mop 160 of the cleaner 10 requires to be washed or sterilized, the user may input the mop wash command and/or the mop steam command via the input interface.

The cleaner 10 may return to the station 20 based on receiving the mop wash command and/or the mop steam command via the input interface.

Based on receiving the mop wash command and/or the mop steam command via the input interface, the cleaner 10 may transmit a mop wash request signal and/or a mop steam request signal to the station 20.

Accordingly, in a case where the cleaner 10 returns to the station 20 and docks with the station 20, the station 20 may perform a washing process (e.g., cleaning process and/or steam process).

The motion driver 120 may include traveling wheels 121 and 122 arranged in the main body 110, and a wheel motor that provides power to the traveling wheels 121 and 122.

Rotation of the traveling wheels 121 and 122 may move the main body 110. Rotation of the traveling wheels 121 and 122 may move the main body 110 forward, backward, or rotate the main body 110. For example, by rotation of both the left and right traveling wheels 121 and 122 in a forward direction, the main body 110 may move straight forward, and by rotation of both the left and right traveling wheels 121 and 122 in a backward direction, the main body 110 may move straight backward.

In addition, in a case where the left and right traveling wheels 121 and 122 rotate in the same direction but at different speeds, the main body 110 may turn to the right or left. In a case where the left and right traveling wheels 121 and 122 rotate in different directions, the main body 110 may rotate in place and turn left or right.

The wheel motor may generate rotational force to rotate the traveling wheels 121 and 122. A direct current (DC) motor or a brushless DC electric motor (BLDC) may be used as the wheel motor, but an embodiment of the cleaner 10 is not limited thereto. In addition to the wheel motor, the types of other motors included in the cleaner 10 are not limited.

The wheel motor may include a left wheel motor that rotates the left traveling wheel and a right wheel motor that rotates the right traveling wheel.

Each of the left and right wheel motors may operate independently of each other according to a control signal from the first controller 190, and the main body 110 may move forward, backward, or rotate according to the operation of the left and right wheel motors.

The first controller 190 may control the movement of the cleaner 10 by controlling the motion driver 120 (e.g., wheel motor).

The brush motor 133 may rotate the brush 130.

The first controller 190 may control the brush motor 133 to rotate the brush 130 during dry cleaning, thereby allowing the brush 130 to scatter foreign substances on the floor.

The intake motor 142 may draw the foreign substances scattered by the brush 130 into the dust bin and may rotate an intake fan that generates a suction force to draw the foreign substances into the dust bin.

The first controller 190 may control the intake motor 142 to rotate the intake fan during dry cleaning, thereby allowing the foreign substances scattered by the brush 130 to draw into the dust bin through the inlet 111.

The first controller 190 may control an intensity of the intake motor 142. The intensity of the intake motor 142 may correspond to a rotational speed of the intake motor 142 and/or a duty ratio of the intake motor 142.

The driver 163 may include the rotation driver 161 that rotates the mop 160 and/or the lifting driver 162 that lifts (raises) or lowers the mop 160.

The first controller 190 may control the rotation driver 161 to rotate the mop 160. The rotation driver 161 may include a motor for rotating the mop 160 and a drive circuit for driving the motor.

The first controller 190 may control the lifting driver 162 to lift or lower the mop 160. That is, the first controller 190 may control the lifting driver 162 to move the mop 160. The lifting driver 162 may include an actuator capable of moving the mop 160.

The communication circuitry 182 may communicate with an external device (e.g., a server, a user device, the station 20) wired and/or wirelessly.

The communication circuitry 182 may transmit data to an external device (e.g., a server, a user device, and/or the station 20) or receive data from the external device. For the communication, the communication circuitry 182 may establish a direct (e.g., wired) communication channel or a wireless communication channel between external devices, and support the performance of the communication through the established communication channel. According to an embodiment, the communication circuitry 182 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include a mobile communication interface. The mobile communication interface transmits and receives radio signals with at least one of a base station, an external terminal, or a server on a mobile communication network.

In an embodiment, the communication circuitry 182 may communicate with an external device through a nearby access point (AP). The AP may connect a local area network (LAN), to which the cleaner 10 is connected, to a wide area network (WAN) to which a server is connected. The cleaner 10 may be connected to the server through the wide area network (WAN).

In an embodiment, the communication circuitry 182 may communicate wirelessly with the station 20.

The first controller 190 may control an overall operation of the cleaner 10.

The first controller 190 may include at least one processor 191 that controls an operation of the cleaner 10 and at least one memory 192 storing programs and data for controlling the operation of the cleaner 10.

The at least one processor 191 may control overall operations of the cleaner 10. Specifically, the at least one processor 191 may be connected to each component of the cleaner 10 and may control overall operations of the cleaner 10. For example, the at least one processor 191 may be electrically connected to the memory 192 to control the overall operations of the cleaner 10. A single processor 191 or a plurality of processors 191 may be provided.

The at least one processor 191 may execute at least one instruction stored in the memory 192, thereby allowing the cleaner 10 to perform operations according to various embodiments.

The at least one memory 192 may store data required for various embodiments. The memory 192 may be implemented as a memory embedded in the cleaner 10 or as a memory detachable from the cleaner 10 depending on a data storage use. For example, data for driving the cleaner 10 may be stored in the memory embedded in the cleaner 10, and data for an extended function of the cleaner 10 may be stored in the memory detachable from the cleaner 10.

Meanwhile, the memory embedded in the cleaner 10 may be implemented as at least one of a volatile memory (e.g., dynamic random access memory (DRAM), static RAM (SRAM), or synchronous dynamic RAM (SDRAM), etc.), or a non-volatile memory (e.g., one time programmable read only memory (OTPROM), programmable ROM (PROM), erasable programmable ROM (EPROM), electrically erasable programmable ROM (EEPROM), mask ROM, flash ROM, flash memory (e.g. NAND flash or NOR flash, etc.), a hard drive, or a solid state drive (SSD)). In addition, the memory detachable from the cleaner 10 may be implemented as a memory card (e.g., compact flash (CF), secure digital (SD), micro secure digital (Micro-SD), mini secure digital (Mini-SD), extreme digital (xD), multi-media card (MMC), etc.), an external memory (e.g., universal serial bus (USB) memory) connectable to a USB port, and the like.

The at least one processor 191 may include at least one of a central processing unit (CPU), graphics processing unit (GPU), accelerated processing unit (APU), many integrated core (MIC), digital signal processor (DSP), neural processing unit (NPU), hardware accelerator, or machine learning accelerator. The at least one processor 191 may control one or any combination of other components of the cleaner 10, and may perform communication-related operations or data processing. The at least one processor 191 may execute at least one program or instruction stored in the memory 192. For example, the at least one processor 191 may execute at least one instruction stored in the memory 192 to perform a method according to at least an embodiment of the disclosure.

In an embodiment, the first controller 190 may control the driver 163 according to a predetermined condition. Controlling the driver 163 may include rotating or moving the mop 160. Moving the mop 160 may include lifting or lowering the mop 160.

In an embodiment, the first controller 190 may control the motion driver 120 according to a predetermined condition. Controlling the motion driver 120 may include moving the cleaner 10.

In an embodiment, the first controller 190 may control the brush motor 133 and/or the intake motor 142 according to a predetermined condition.

FIG. 15 is a control block diagram of a station according to an embodiment.

Referring to FIG. 15, the station 20 may include a docking sensor 270, the intake motor 224, a user interface 281, communication circuitry 282, the at least one pump 21, the at least one valve 23, the heating device 250, the drying device 260, and/or the controller 290.

Hereinafter, for convenience of description, the controller 290 of the station 20 is referred to as the second controller 290.

The docking sensor 270 may detect whether the cleaner 10 is docked at the station 20. The docking sensor 270 may include at least one sensor that detects mechanical and/or electrical changes when the cleaner 10 is docked at the station 20.

For example, the docking sensor 270 may include a sensor for detecting whether the charging terminal 151 of the cleaner 10 is electrically connected to the charging terminal 218 of the station 20. In another example, the docking sensor 270 may include a sensor (e.g., an elastic sensor) that detects mechanical deformation when the cleaner 10 is docked.

In still another example, the docking sensor 270 may include the above-described docking sensor 250s.

The second controller 290 may determine whether the cleaner 10 is docked to the station based on an output value of the docking sensor 270.

The intake motor 224 may generate a suction force to draw dirt from the dust bin.

The second controller 290 may draw the dirt from the dust bin into the dirt container 223 by operating the intake motor 224.

The operation of the second controller 290 to operate the intake motor 224 to draw the dirt from the dust bin into the dirt container 223 may be referred to as an intake process.

The user interface 281 may include an output interface and an input interface.

At least one output interface may generate sensory information and transmit various information related to operations of the station to a user.

For example, the at least one output interface may transmit information related to settings, operation time, and the like, of the station to the user. Information about the operation of the station may be output through a display, indicator, and/or may be output as voice. The at least one output interface may include, for example, a liquid crystal display (LCD) panel, an indicator, a light emitting diode (LED) panel, a speaker, and the like.

In a case where the display includes a touch screen display, the touch screen display may correspond to an example of the output interface and the input interface.

In an embodiment, the at least one output interface may output sensory information (e.g., visual information, auditory information, etc.) related to control of the station.

At least one input interface may convert the sensory information received from the user into an electrical signal.

The at least one input interface may include a power button for turning on the station.

Each button may include a visual indicator (e.g. text, icon, etc.) that may indicate its function.

The at least one input interface may include, for example, a tact switch, a push switch, a slide switch, a toggle switch, a micro switch, a touch switch, a touch pad, a touch screen, a jog dial, and/or a microphone, and the like.

In the disclosure, a “button” may be replaced by a user interface element (UI element), a tact switch, a push switch, a slide switch, a toggle switch, a micro switch, a touch switch, a touch pad, a touch screen, a jog dial, and/or a microphone, and the like.

The station 20 may process a user input received via the user interface 281 and may output information related to the station via the user interface 281.

In an embodiment, the user interface 281 may include an input interface for receiving a mop wash command and/or a mop steam command.

When a user determines that the mop 160 of the cleaner 10 requires to be washed (e.g., cleaned and/or sterilized), the user may input the mop wash command (e.g., a mop clean command and/or a mop steam command) via the input interface.

The station 20 may perform a washing process (e.g., a cleaning process and/or a steam process) and/or a drying process in response to the mop wash command being input via the user interface 281.

The communication circuitry 282 may communicate with an external device (e.g., a server, a user device, the cleaner 10) wired and/or wirelessly.

The communication circuitry 282 may transmit data to an external device (e.g., a server, a user device, and/or the cleaner 10) or receive data from the external device. For the communication, the communication circuitry 282 may establish a direct (e.g., wired) communication channel or a wireless communication channel between external devices, and support the performance of the communication through the established communication channel. According to an embodiment, the communication circuitry 282 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include a mobile communication interface. The mobile communication interface transmits and receives radio signals with at least one of a base station, an external terminal, or a server on a mobile communication network.

In an embodiment, the communication circuitry 282 may communicate with an external device through a nearby access point (AP). The AP may connect a local area network (LAN), to which the cleaner 10 is connected, to a wide area network (WAN) to which a server is connected. The station 20 may be connected to the server through the wide area network (WAN).

In an embodiment, the communication circuitry 282 may communicate wirelessly with the cleaner 10.

A variety of examples may be employed as a communication method between the cleaner and the station 20.

In an embodiment, the cleaner 10 and the station 20 may communicate directly through a short-range wireless communication module.

In an embodiment, the cleaner 10 and the station 20 may communicate directly through wired communication in a state where the cleaner 10 is docked at the station 20.

In an embodiment, the cleaner 10 and the station 20 may communicate indirectly through a long-range wireless communication module via an external server.

Indirect communication via an external server may include, in response to transmitting a predetermined signal to an external server from the cleaner 10, transmitting the predetermined signal to the station 20 by the external server, and/or in response to transmitting a predetermined signal to an external server from the station 20, transmitting the predetermined signal to the cleaner 10 by the external server.

The at least one pump 21 may pump water stored in the water storage container 221 to the heating device 250 or pump water stored in the heating device 250.

In a case where internal components of the pump 21 rotate in a first direction, the water stored in the water storage container 221 may be pumped, and in a case where the internal components of the pump 21 rotate in a second direction opposite to the first direction, the water in the heating device 250 may be pumped.

The at least one pump 21 may pump air in the wastewater container 222. The air in the wastewater container 222 may be discharged from the wastewater container 222 by the at least one pump 21.

The station 20 may perform an operation of collecting wastewater from the washing chamber 230. The at least one pump 21 may pump air of the wastewater container 222. By discharging the air in the wastewater container 222 to the outside, the inside of the wastewater container 222 may become negative pressure, and the wastewater contained in the washing chamber 230 may flow into the wastewater container 222.

The second controller 290 may control a pumping direction of the at least one pump 21 and operate the at least one pump 21.

The second controller 290 may operate the at least one pump 21.

A water level sensor (not shown) disposed in the wastewater container 222 may transmit information about a water level of the wastewater container 222 to the second controller 290.

The second controller 290 may control the at least one pump 21 based on the information obtained from the water level sensor. The second controller 290 may stop the at least one pump 21 based on the water level in the wastewater container 222 reaching a predetermined water level.

The at least one valve 23 may adjust a flow of water pumped by the at least one pump 21 and may operate based on a control signal from the second controller 290.

The heating device 250 may include the heater 252, the water level sensor 253, and/or the temperature sensor 254.

The heater 252 may heat water in the steam container 251 and may operate based on a control signal from the second controller 290.

The water level sensor 253 may detect a water level in the steam container 251.

For example, the water level sensor 253 may be implemented as a pressure sensor, an optical sensor, an ultrasonic sensor, and the like, that may measure the water level in the steam container 251.

In another example, the water level sensor 253 may be implemented as an electrode sensor that may detect that the water level of the steam container 251 has reached a predetermined water level.

The water level sensor 253 may transmit information about the water level of the steam container 251 to the second controller 290.

In an embodiment, the water level sensor 253 may detect that the water level of the steam container 251 has reached the predetermined water level, and in response to the water level of the steam container 251 reaching the predetermined water level, the water level sensor 253 may transmit an electrical signal to the second controller 290.

The second controller 290 may operate the heater 252 based on the predetermined water level being detected by the water level sensor 253.

The temperature sensor 254 may detect a temperature in the steam container 251 and may transmit information related to the temperature in the steam container 251 to the second controller 290.

In an embodiment, the second controller 290 may control the heater 252 based on temperature information received from the temperature sensor 254. For example, the second controller 290 may stop the operation of the heater 252 based on the temperature detected by the temperature sensor 254 reaching a predetermined temperature.

The second controller 290 may perform a washing process by driving the at least one pump 21, the at least one valve 23, and the heating device 250 described above.

In an embodiment, the second controller 290 may start the washing process in response to a washing process start condition being satisfied.

Driving the heating device 250 by the second controller 290 may include controlling the heating device 250 to spray heated water (e.g., steam) from the heating device 250 to the washing chamber 230.

Steam may be supplied to the washing chamber 230 by driving the heating device 250.

In response to the start of the washing process, the second controller 290 may control the at least one valve 23 to allow communication between the water storage container 221 and the steam container 251, and may control the at least one pump 21 to pump the water stored in the water storage container 221. Accordingly, the water stored in the water storage container 221 may flow to the heating device 250.

Thereafter, the second controller 290 may operate the heater 252 based on the predetermined water level being detected by the water level sensor 253, thereby allowing the heated water (e.g., steam) to be sprayed into the washing chamber 230 from the heating device 250. The second controller 290 may stop the operation of the at least one pump 21 based on the predetermined water level being detected by the water level sensor 253.

The second controller 290 may operate the heater 252 until the washing process ends based on the predetermined water level being detected by the water level sensor 253, and may also temporarily stop the operation of the heater 252 based on the temperature detected by the temperature sensor 254 reaching the predetermined temperature during the washing process. Accordingly, the heater 252 may be prevented from overheating.

The second controller 290 may end the washing process based on a washing process end condition being satisfied.

In an embodiment, the second controller 290 may end the washing process in response to the predetermined water level (minimum water level) being detected by the water level sensor 253.

In an embodiment, the second controller 290 may end the washing process in response to an execution time of the washing process exceeding a predetermined time.

In an embodiment, the washing process may include a process (cleaning process) in which the heating device 250 heats the water stored in the water storage container 221 and the heated water is provided to the washing chamber 230 through the second water supply 231.

The second controller 290 may control the communication circuitry 282 to transmit a washing process end signal to the cleaner 10 in response to the end of the washing process.

The second controller 290 may perform a water recovery operation in response to the end of the washing process.

In an embodiment, the second controller 290 may perform a water recovery operation based on a predetermined time having elapsed after the end of the washing process.

In an embodiment, the second controller 290 may perform a water recovery operation based on a predetermined time having elapsed after the heater 252 is turned off in response to the end of the washing process.

The predetermined time may be set in advance as a time for the water heated by the heating device 250 to cool sufficiently.

In an embodiment, after the heater 252 is turned off in response to the end of the washing process, the second controller 290 may perform a water recovery operation based on the temperature detected by the temperature sensor 254 falling below a predetermined temperature.

According to the disclosure, microorganisms may be prevented from growing in the water storage container 221 by hot water recovered in the water storage container 221.

In response to the end of the washing process, the second controller 290 may control the at least one valve 23 to allow communication between the heating device 250 and the water storage container 221, and may control the at least one pump 21 to pump the water remaining in the heating device 250. Accordingly, the water in the heating device 250 may flow to the water storage container 221.

In response to the end of the washing process, the second controller 290 may control the at least one valve 23 to allow communication between the washing chamber 230 and the wastewater container 222, and may control the at least one pump 21 to pump the air in the wastewater container 222 to the outside. Accordingly, the water in the washing chamber 230 may flow to the wastewater container 222.

The second controller 290 may stop the heating device 250 in response to the end of the washing process. Stopping the heating device 250 may include turning off the heater 252.

The second controller 290 may end the water recovery operation according to various conditions.

In an embodiment, the second controller 290 may end the water recovery operation in response to an execution time of the water recovery operation exceeding a predetermined time.

In an embodiment, the second controller 290 may start a drying process in response to the end of the water recovery operation.

The drying device 260 may include the heater 263 that heats air, and the fan 262 that blows the heated air. Air heated by the heater 263 may be blown into the washing chamber 230 according to the operation of the fan 262.

The second controller 290 may control the drying device 260 to blow the heated air into the washing chamber 230, thereby performing the drying process.

The second controller 290 may perform the drying process by operating the heater 263 and the fan 262.

The second controller 290 may end the drying process according to a drying process end condition.

In an embodiment, the second controller 290 may end the drying process in response to an execution time of the drying process exceeding a predetermined time.

In an embodiment, the second controller 290 may end the drying process in response to receiving a drying end request signal from the cleaner 10. To this end, the cleaner 10 may transmit the drying end request signal to the station 20 in response to a humidity measured by the humidity sensor 171 falling below a predetermined humidity during the drying process.

The second controller 290 may control overall operations of the station 20.

The second controller 290 may include at least one processor 291 that controls an operation of the station 20 and at least one memory 292 storing programs and data for controlling the operation of the station 20.

The at least one processor 291 may control overall operations of the station 20. Specifically, the at least one processor 291 may be connected to each component of the station 20 and may control overall operations of the station 20. For example, the at least one processor 291 may be electrically connected to the memory 292 to control the overall operations of the station 20. A single processor 291 or a plurality of processors 291 may be provided.

The at least one processor 291 may execute at least one instruction stored in the memory 292, thereby allowing the station 20 to perform operations according to various embodiments.

The at least one memory 292 may store data required for various embodiments. The memory 292 may be implemented as a memory embedded in the station 20 or as a memory detachable from the station 20 depending on a data storage use. For example, data for driving the station 20 may be stored in the memory embedded in the station 20, and data for an extended function of the station 20 may be stored in the memory detachable from the station 20. Meanwhile, the memory embedded in the station 20 may be implemented as at least one of a volatile memory (e.g., dynamic random access memory (DRAM), static RAM (SRAM), or synchronous dynamic RAM (SDRAM), etc.), or a non-volatile memory (e.g., one time programmable read only memory (OTPROM), programmable ROM (PROM), erasable programmable ROM (EPROM), electrically erasable programmable ROM (EEPROM), mask ROM, flash ROM, flash memory (e.g. NAND flash or NOR flash, etc.), a hard drive, or a solid state drive (SSD)). In addition, the memory detachable from the station 20 may be implemented as a memory card (e.g., compact flash (CF), secure digital (SD), micro secure digital (Micro-SD), mini secure digital (Mini-SD), extreme digital (xD), multi-media card (MMC), etc.), an external memory (e.g., universal serial bus (USB) memory) connectable to a USB port, and the like.

The at least one processor 291 may include a at least one of a central processing unit (CPU), graphics processing unit (GPU), accelerated processing unit (APU), many integrated core (MIC), digital signal processor (DSP), neural processing unit (NPU), hardware accelerator, or machine learning accelerator. The at least one processor 291 may control one or any combination of other components of the station 20, and may perform communication-related operations or data processing. The at least one processor 291 may execute at least one program or instruction stored in the memory 292. For example, the at least one processor 291 may execute at least one instruction stored in the memory 292 to perform a method according to at least an embodiment of the disclosure.

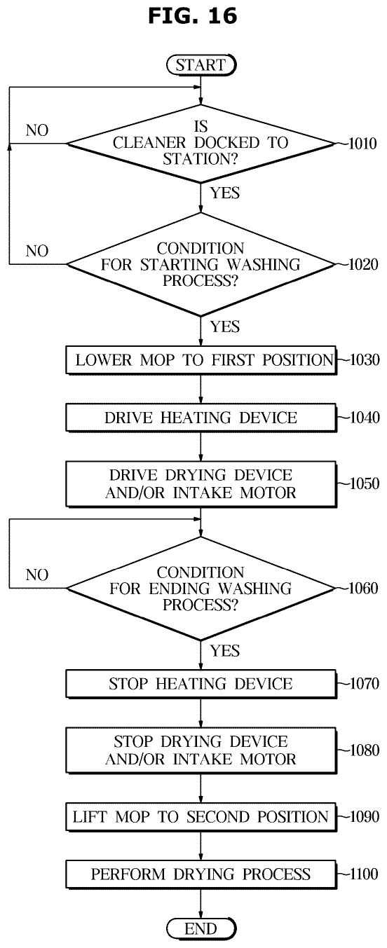

FIG. 16 is a flowchart illustrating an example method for controlling a cleaning system according to an embodiment.

Hereinafter, for convenience of description, it is assumed that the controllers 190 and 290 of the cleaning system 1 includes the first controller 190 and the second controller 290.

The first controller 190 and the second controller 290 may transmit and receive various information through the communication circuitry 182 and 282. The first controller 190 may control an operation of the cleaner 10. The second controller 290 may control an operation of the station 20.

Referring to FIG. 16, the controllers 190 and 290 may determine whether the cleaner 10 is docked to the station 20 (1010).

In an embodiment, the controller 190 may determine whether the cleaner 10 is docked to the station 20 based on processing data collected by the docking sensor 150s. The controller 190 may determine that the cleaner 10 is docked to the station 20 based on a start of charging of the cleaner 10.

In an embodiment, the controller 290 may determine whether the cleaner 10 is docked to the station 20 based on processing data collected by the docking sensor 250s. The controller 290 may determine that the cleaner 10 is docked to the station 20 based on a start of charging of the cleaner 10.

The controllers 190 and 290 may determine whether a condition for starting a washing process is satisfied (1020).

In an embodiment, the controller 190 may determine that the condition for starting the washing process is satisfied based on receiving a wash command via the user interface 181 or receiving a wash command from an external device via the communication circuitry 182.

In an embodiment, the controller 190 may determine that the condition for starting the washing process is satisfied, based on completion of cleaning according to a preset cleaning schedule or a humidity value measured by the humidity sensor 171 falling within a preset range.

Based on determining that the condition for starting the washing process is satisfied, the controller 190 may control the communication circuitry 182 to transmit a signal requesting the washing process to the station 20.

In an embodiment, the controller 290 may determine that the condition for starting the washing process is satisfied based on receiving a wash command via the user interface 281 or receiving a wash command from an external device via the communication circuitry 282.

Based on determining that the condition for starting the washing process is satisfied, the controller 290 may control the communication circuitry 282 to transmit a signal requesting the cleaner 10 to return to the station 20.

In an embodiment, the controller 290 may determine that the condition for starting the washing process is satisfied based on the cleaner 10 being separated from the station 20 and then placed back on.

According to various embodiments, operation 1020 may be performed before operation 1010.

The controllers 190 and 290 may start the washing process based on the condition for starting the washing process being satisfied.

In the disclosure, the washing process may include a steam process and/or a cleaning process.

The steam process and/or the cleaning process may include driving the heating device 250 to provide heated water (steam) to the mop 160 accommodated in the washing chamber 230.

The controllers 190 and 290 may lower the mop 160 to a first position based on the start of the washing process (1030). Here, the first position may correspond to a position where the mop 160 is seated on the washing frame 240. That is, when the mop 160 is in the first position, the mop 160 may come into contact with the washing frame 240.

The controllers 190 and 290 may drive the heating device 250 based on the start of the washing process (1040). For example, the controllers 190 and 290 may drive the heating device 250 after lowering the mop 160 to the first position.

Here, driving the heating device 250 includes supplying heated water and/or steam (hereinafter collectively referred to as “steam”) to the washing chamber 230.

The controller 190 may transmit a lowering completion signal to the controller 290 in response to completion of lowering the mop 160 to the first position, and the controller 290 may drive the heating device 250 in response to receiving the lowering completion signal from the controller 190.

That is, the controllers 190 and 290 may drive the heating device 250 in response to the completion of the lowering of the mop 160 to the first position.

The controllers 190 and 290 may rotate the mop 160 during the washing process. As the mop 160 rotates, washing and/or sterilization of the mop 160 may be performed more smoothly.

Meanwhile, while the heating device 250 is driven, steam may be discharged to the outside of the washing chamber 230, and thus water may form around the main body 110 of the cleaner 10 and/or in the station 20.

A sensor window corresponding to the docking sensor 150s may be disposed around the main body 110 of the cleaner 10. A sensor window corresponding to the docking sensor 250s may be disposed in the station 20.

In a case where steam is discharged outside of the washing chamber 230 and water forms around the main body 110 of the cleaner 10 and/or in the station 20, water may form on the sensor window, causing a docking detection error.

In addition, in a case where steam is discharged outside of the washing chamber 230 and water forms around the main body 110 of the cleaner 10 and/or in the station 20, an area around the main body 110 of the cleaner 10 and/or in the station 20 may become contaminated.

In addition, in a case where steam is discharged outside of the washing chamber 230 and water forms around the main body 110 of the cleaner 10 and/or in the station 20, water may also form on the charging terminals 151 and 218, causing an electrical hazard when charging the battery 150 of the cleaner 10.

Accordingly, it is required to prevent water from forming around the main body 110 of the cleaner 10 and/or in the station 20 due to the steam discharged to the outside of the washing chamber 230 during the washing process.

The controllers 190 and 290 may drive at least one of the drying device 260 of the station 20 or the intake motor 142 of the cleaner 10 while the heating device 250 is driven (1050).

While steam is supplied to the washing chamber 230 by driving the heating device 250, the station 20 may drive the drying device 260.

By driving the drying device 260 while steam is supplied to the washing chamber 230, air may flow to the main body 110 of the cleaner 10.

While steam is supplied to the washing chamber 230 by driving the heating device 250, the cleaner 10 may drive the intake motor 142.

By driving the intake motor 142 while steam is supplied to the washing chamber 230, the air introduced into the main body 110 of the cleaner 10 may flow to the outside of the main body 110 of the cleaner 10.

That is, the controllers 190 and 290 may drive the drying device 260 and/or the intake motor 142 while the mop 160 is in the first position.

Driving the drying device 260 and/or the intake motor 142 while the heating device 250 is driven may include not only turning on the drying device 260 and/or the intake motor 142 while the heating device 250 is being driven, but also turning on the drying device 260 and/or the intake motor 142 before the heating device 250 is driven or after the heating device 250 is driven. Furthermore, the controllers 190 and 290 may turn on the drying device 260 and/or the intake motor 142 after the heating device 250 is stopped after being driven.

Driving at least one of the drying device 260 or the intake motor 142 may include driving only the drying device 260, driving only the intake motor 142, or driving both the drying device 260 and the intake motor 142.

Driving the drying device 260 may include rotating the fan 262.

Driving the intake motor 142 may include rotating the intake fan.

According to the disclosure, by driving at least one of the drying device 260 of the station 20 or the intake motor 142 of the cleaner 10 while the heating device 250 is driven, water may be prevented from forming around the main body 110 of the cleaner 10 and/or in the station 20.

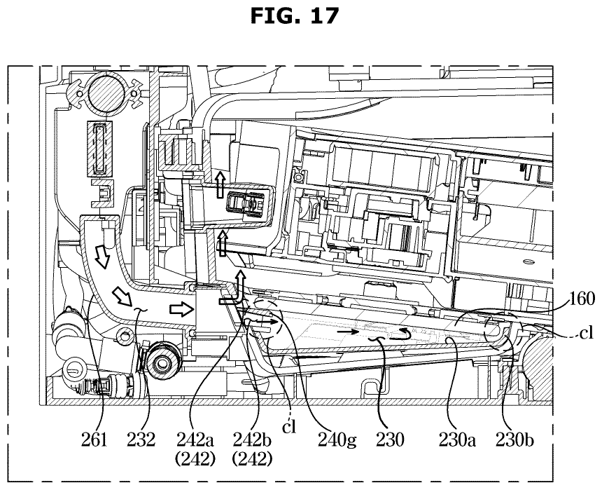

FIG. 17 is a schematic view illustrating a flow of air supplied by a drying device of a station while a mop of a cleaner is in a first position according to an embodiment.

Referring to FIG. 17, the mop 160 may contact the washing frame 240 while the mop 160 is in the first position.

For example, the mop 160 may contact the guide member 240g (or the frame body 240a).

In the disclosure, the washing chamber 230 is a space defined by the chamber bottom 230a and the chamber side wall 230b extending upward from the chamber bottom 230a, and a portion c1 of the washing chamber 230 may be opened. Accordingly, the washing chamber 230 may be referred to as an open chamber, an open room, a niche, or a wall.

The open portion c1 may correspond to the frame opening 240c described above.

In the disclosure, in a case where the open portion c1 is closed by the mop 160, the washing chamber 230 may be a space defined by the chamber bottom 230a, the chamber side wall 230b, and the frame body 240a.

The mop 160 may be accommodated in the washing chamber 230 through the open portion c1 of the washing chamber 230.

The mop 160 being accommodated in the washing chamber 230 may refer to the mop 160 being contained in the space defined by the chamber bottom 230a and the chamber side wall 230b extending upward from the chamber bottom 230a.

The mop 160 may close the open portion c1 of the washing chamber 230 while the mop 160 is in the first position. Accordingly, the washing chamber 230 may be defined by the mop 160, the chamber side wall 230b, and the guide member 240g.

That is, the washing chamber 230 may be closed while the mop 160 is in the first position. In the disclosure, closing the washing chamber 230 may include closing the open portion c1 of the washing chamber 230.

In a case where the open portion c1 of the washing chamber 230 is closed and the washing chamber 230 is defined by the mop 160, the chamber side wall 230b, and the guide member 240g, the inside of the washing chamber 230 may refer to the space defined (enclosed) by the mop 160, the chamber side wall 230b, and the guide member 240g, and the outside of the washing chamber 230 may refer to an area external to the space defined by the mop 160, the chamber side wall 230b, and the guide member 240g.

Meanwhile, as described above, because the open portion c1 of the washing chamber 230 is closed by the mop 160 which allows fluid to easily permeate, steam introduced into the washing chamber 230 may leak out of the washing chamber 230.

The dry air supply 232 may be divided into the first flow path 242a and the second flow path 242b by the guide member 240g. The first flow path 242a may be a flow path on an upper side of the guide member 240g, and the second flow path 242b may be a flow path on a lower side of the guide member 240g.

The steam discharge opening 243 shown in FIG. 12 may be disposed on the lower side of the guide member 240g to supply steam to the inside of the washing chamber 230.

In a case where the mop 160 is in the first position, the second flow path 242b is directed toward the inside of the washing chamber 230 defined by the mop 160, the chamber bottom 230a, the chamber side wall 230b, and the guide member 240g, and the first flow path 242a is directed toward the outside of the washing chamber 230 defined by the mop 160, the chamber bottom 230a, the chamber side wall 230b, and the guide member 240g.

In an embodiment, while the mop 160 is in the first position, the guide member 240g and the mop 160 are in contact, thereby allowing the air flowing through the first flow path 242a to be directed toward the outside of the washing chamber 230, and allowing the air flowing through the second flow path 242b to be directed toward the inside of the washing chamber 230.

Because the washing chamber 230 is a closed space, supplying air to the dry air supply 232 may cause the pressure inside the washing chamber 230 to become higher than the pressure outside the washing chamber 230. Accordingly, the air supplied to the washing chamber 230 by driving the drying device 260 while the mop 160 is in the first position may flow more to the outside of the washing chamber 230 than to the inside of the washing chamber 230.

Here, the inside of the washing chamber 230 may be the washing chamber 230 itself, and the outside of the washing chamber 230 may refer to a space outside the washing chamber 230.

The air flowing to the outside of the washing chamber 230 through the first flow path 242a by driving the drying device 260 while the mop 160 is in the first position may flow to a space between the docking sensor 150s of the cleaner 10 and the docking sensor 250s of the station 20.

The air flowing to the outside of the washing chamber 230 through the first flow path 242a by driving the drying device 260 while the mop 160 is in the first position may dry water formed around the main body 110 of the cleaner 10 and/or in the station 20.

According to the disclosure, by driving the drying device 260 during the washing process, water formed around the main body 110 of the cleaner 10 and/or in the station 20 may be immediately removed.

According to the disclosure, by driving the drying device 260 during the washing process, water formed around the docking sensor 150s of the cleaner 10 and/or the docking sensor 250s of the station 20 may be immediately removed.

According to the disclosure, because the steam discharge opening 243 is positioned below the guide member 240g and steam may be supplied to the inside of the washing chamber 230 defined by the mop 160, the chamber side wall 230b, and the guide member 240g while the mop 160 is in the first position, an excessive amount of steam may be prevented from being transferred to a periphery of the main body 110 of the cleaner 10 and/or the station 20.

According to the disclosure, because the heating device 250 is driven in response to the completion of the lowering of the mop 160 to the first position, an excessive amount of steam may be prevented from being transferred to the periphery of the main body 110 of the cleaner 10 and/or the station 20.

FIG. 18 is a schematic view illustrating a flow of air while an intake motor of a cleaner is driven.

Referring to FIG. 18, when the intake motor 142 is driven, air drawn into the inlet 111 may be discharged through the dust bin to the outlet 112.

In an embodiment, the outlet 112 may be disposed below the docking sensor 150s (see FIG. 5).

When the intake motor 142 is driven, air discharged through the outlet 112 may flow to a space between the cleaner 10 and the station 20.

For example, when the intake motor 142 is driven, air discharged through the outlet 112 may flow to a space between the docking sensor 150s of the cleaner 10 and the docking sensor 250s of the station 20.

To this end, the outlet 112 may be formed at a position facing the docking sensor 250s of the station 20 while the cleaner 10 is docked to the station 20.

The docking sensor 250s of the station 20 and the docking sensor 150s of the cleaner 10 may face each other while the cleaner 10 is docked to the station 20.

When the intake motor 142 is driven, the air discharged through the outlet 112 may be blown toward the station 20, and the air reflected from the station 20 may flow toward the cleaner 10, thereby removing water formed on the main body of the cleaner 10 and the station 20.

For example, when the intake motor 142 is driven, the air discharged through the outlet 112 may be blown toward the docking sensor 250s of the station 20, and the air reflected from the docking sensor 250s of the station 20 may flow toward the docking sensor 150s of the cleaner 10, thereby removing water formed on the docking sensor 250s of the station 20 and the docking sensor 150s of the cleaner 10.

According to the disclosure, by driving the intake motor 142 during the washing process, water formed around the main body 110 of the cleaner 10 and/or in the station 20 may be immediately removed.

According to the disclosure, by driving the intake motor 142 of the cleaner 10 during the washing process, water formed on the docking sensor 150s of the cleaner 10 and/or the docking sensor 250s of the station 20 may be immediately removed.

Meanwhile, driving the intake motor 142 of the cleaner 10 during the washing process may generate noise, which may cause discomfort to a user.

In an embodiment, the controllers 190 and 290 may control an intensity of the intake motor 142 during the washing process to be less than an intensity of the intake motor 142 while the cleaner 10 performs cleaning.

For example, the controllers 190 and 290 may drive the intake motor 142 with a first intensity while the cleaner 10 performs cleaning, and may drive the intake motor 142 with a second intensity less than the first intensity while the heating device 250 is driven.

Driving the intake motor 142 with the first intensity may include rotating the intake motor 142 at a first rotation speed. Driving the intake motor 142 with the second intensity less than the first intensity may include rotating the intake motor 142 at a second rotation speed that is slower than the first rotation speed.

Driving the intake motor 142 with the first intensity may include driving the intake motor 142 at a first duty ratio. Driving the intake motor 142 with the second intensity less than the first intensity may include driving the intake motor 142 at a second duty ratio less than the first duty ratio.

According to the disclosure, noise caused by driving the intake motor 142 during the washing process may be minimized.

According to various embodiments, the controllers 190 and 290 may receive information about whether a person is present in a house from an external device through the communication circuitry 182 and 282.

Here, ‘in a house’ may refer to an indoor space where the station 20 is installed.

The controllers 190 and 290 may increase an intensity of the intake motor 142 based on the absence of a person in the house during the washing process. Here, increasing the intensity of the intake motor 142 may refer to driving the intake motor 142 at an intensity greater than the second intensity.

According to the disclosure, in a case where there is no person in the house, the intensity of the intake motor 142 may be increased, thereby removing water formed around the main body 110 of the cleaner 10 and/or in the station 20 more efficiently.

Referring back to FIG. 16, the controllers 190 and 290 may determine whether a condition for ending the washing process is satisfied (1060).

The condition for ending the washing process may include various conditions, such as an elapse of a preset washing process execution time, receipt of a command to start a drying process, and the like.

The controllers 190 and 290 may stop the heating device 250 (1070), based on the condition for ending the washing process being satisfied (Yes in operation 1060). According to various embodiments, the heating device 250 may be intermittently stopped even during the washing process, and the washing process may be terminated in a state where the heating device 250 is stopped before the end of the washing process.

The controllers 190 and 290 may stop the drying device 260 and/or the intake motor 142 based on the stopping of the heating device 250 (1080).

According to various embodiments, the controllers 190 and 290 may not stop the drying device 260 and/or the intake motor 142 for a predetermined period of time, even after the heating device 250 is stopped.

That is, the controllers 190 and 290 may continue to drive the drying device 260 and/or the intake motor 142 for a predetermined period of time after the heating device 250 is stopped.

According to the disclosure, water formed around the main body 110 of the cleaner 10 and/or in the station 20 may be efficiently removed.

According to various embodiments, in a case where the drying process is scheduled to be performed after the end of the washing process, the controllers 190 and 290 may not stop the drying device 260 and/or the intake motor 142. That is, operation 1080 may be omitted.

In an embodiment, in a case where the drying process is scheduled to be performed after the end of the washing process, the controllers 190 and 290 may continue to drive the drying device 260. That is, in a case where the drying process is scheduled to be performed after the end of the washing process, the controllers 190 and 290 may continuously drive the drying device 260 not only when the heating device 250 is driven during the washing process, but also until the drying process is completed.

According to the disclosure, the drying process is performed immediately after the end of the washing process, thereby reducing an execution time for the drying process and saving energy consumed to operate the heater 252.

The controllers 190 and 290 may stop rotation of the mop 160 based on the end of the washing process.

The controllers 190 and 290 may lift the mop 160 to the second position based on the end of the washing process (1090).

For example, the controllers 190 and 290 may lift the mop 160 to the second position based on the heating device 250 being stopped.

The controller 290 may transmit a stop completion signal to the controller 190 based on the heating device 250 being stopped, and the controller 190 may lift the mop 160 to the second position in response to receiving the stop completion signal from the controller 290.

The controller 190 may transmit a lift completion signal to the controller 290 in response to completion of lifting the mop 160 to the second position, and the controller 290 may drive the drying device 260 in response to receiving the lift completion signal from the controller 190. However, according to various embodiments, the controller 290 may continue to drive the drying device 260 without operation 1080.

Here, the second position may be set to a position higher than the first position. In an embodiment, the second position may be set to a position lower than a position of the mop 160 when the cleaner 10 performs dry cleaning without wet cleaning.

According to the disclosure, by lifting the mop 160 to the second position when the heating device 250 is stopped and steam is no longer generated, steam may be prevented from being discharged to the outside of the washing chamber 230 and forming around the main body 110 of the cleaner 10 and/or in the station 20.

The controllers 190 and 290 may perform the drying process based on the mop 160 being lifted to the second position. The drying process is for drying the mop 160 with hot air, and the controllers 190 and 290 may drive the drying device 260 for the drying process.

The controllers 190 and 290 may perform the drying process by driving the drying device 260 while the mop 160 is in the second position (1100).

Meanwhile, in order for the mop 160 to dry, air requires to flow smoothly into the washing chamber 230 to allow hot air to be evenly transferred to the mop 160.

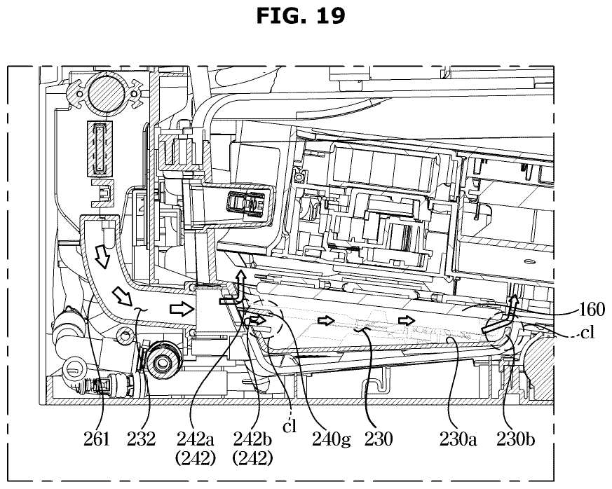

FIG. 19 is a schematic view illustrating a flow of air supplied by a drying device of a station while a mop of a cleaner is in a second position according to an embodiment.

Referring to FIG. 19, the mop 160 may be spaced apart from the washing frame 240 while the mop 160 is in the second position.

For example, the mop 160 may be spaced apart from the guide member 240g (or the frame body 240a).

By spacing the mop 160 from the guide member 240g, the washing chamber 230 may be opened. That is, by spacing the mop 160 from the guide member 240g, the washing chamber 230 may have the open portion c1.

In an embodiment, the mop 160 may be spaced apart from the guide member 240g while the mop 160 is in the second position, and thus the washing chamber 230 may be changed to an open chamber.

When the mop 160 is in the second position, the air flowing through the first flow path 242a and the second flow path 242b may all flow toward the washing chamber 230 defined by the chamber bottom 230a and the chamber side wall 230b. However, because the washing chamber 230 is an open space, when the mop 160 is in the second position, the air flowing through the first flow path 242a and the second flow path 242b may flow to the outside and the inside of the washing chamber 230.

That is, because the washing chamber 230 is an open space, the air supplied to the washing chamber 230 by driving the drying device 260 while the mop 160 is in the second position may flow smoothly through the washing chamber 230.

According to the disclosure, the washing chamber 230 may be closed during the washing process, thereby minimizing leakage of steam, and the washing chamber 230 may be opened during the drying process, thereby allowing the mop 160 to dry smoothly.

In an embodiment, the controllers 190 and 290 may or may not rotate the mop 160 during the drying process.

In an embodiment, the air supplied to the washing chamber 230 by driving the drying device 260 while the mop 160 is in the second position may flow smoothly through the washing chamber 230, and thus the controllers 190 and 290 may not rotate the mop 160.

The controllers 190 and 290 may stop the drying device 260 in response to completion of the drying process.

The controllers 190 and 290 may notify an external device of the completion of the drying process through the communication circuitry 182 and 282 based on the completion of the drying process.

The controllers 190 and 290 may notify the completion of the drying process through the user interfaces 181 and 281 based on the completion of the drying process.

According to the disclosure, steam may be prevented from being discharged to the outside of the washing chamber 230 during a washing process.

According to the disclosure, water may be prevented from forming around the main body 110 of the cleaner 10 and/or in the station 20 during a washing process.

According to the disclosure, water forming around the main body 110 of the cleaner 10 and/or in the station 20 during a washing process may be removed immediately.

According to the disclosure, electrical hazards caused by water forming on charging terminals 151 and 218 during a washing process may be prevented.

According to an embodiment of the disclosure, a cleaning system may include: a cleaner 10 including a main body 110 and a mop 160 provided in the main body 110; and a station 20 to which the cleaner 10 is dockable, the station 20 including a washing chamber 230 configured to receive the mop 160 while the cleaner 10 is docked to the station 20, a water storage container 221, a heating device 250 configured to heat water supplied from the water storage container 221 to supply steam to the washing chamber 230, and a drying device 260 configured to blow air toward the washing chamber 230, wherein the station 20 is configured to drive the heating device 250 to supply the steam to the washing chamber 230 based on a start of a washing process, and drive the drying device 260 while the steam is supplied to the washing chamber 230 to allow air to flow to the main body 110 of the cleaner 10.

The cleaner 10 may be configured to lower the mop 160 to a first position based on the start of the washing process, and lift the mop 160 to a second position higher than the first position based on an end of the washing process.

The air, supplied to the washing chamber 230 by driving the drying device 260 while the mop 160 is in the first position, may flow relatively more to an outside of the washing chamber 230 than to an inside of the washing chamber 230.

The station 20 may further include a guide member 240g configured to divide a flow path of air supplied to the washing chamber 230 by the drying device 260 into a first flow path 242a and a second flow path 242b.

The guide member 240g may be configured to contact the mop 160 while the mop 160 is in the first position to allow air flowing through the first flow path 242a to be directed to an outside of the washing chamber 230 and air flowing through the second flow path 242b to be directed to an inside of the washing chamber 230.

The guide member 240g may be configured to be spaced apart from the mop 160 while the mop 160 is in the second position to allow air flowing through the first flow path 242a and the second flow path 242b to flow to the outside and the inside of the washing chamber 230.

The guide member 240g may be configured to contact the mop 160 while the mop 160 is in the first position to allow the washing chamber 230 to be closed by the mop 160.

The guide member 240g may be configured to be spaced apart from the mop 160 while the mop 160 is in the second position to allow the washing chamber 230 to be opened.

The station 20 may be configured to stop driving the heating device 250 based on the end of the washing process, and drive the drying device 260 while the mop 160 is in the second position to perform a drying process.

The station 20 may be configured to drive the heating device 250 in response to completion of lowering the mop 160 to the first position.

The cleaner 10 may be configured to lift the mop 160 to the second position in response to the heating device 250 stopping.

The cleaner 10 may further include an intake motor 142, and may be configured to drive the intake motor 142 while the steam is supplied to the washing chamber 230 to allow air introduced into the main body 110 to flow to an outside of the main body 110.

The cleaner 10 may be configured to drive the intake motor 142 with a first intensity while the cleaner 10 performs cleaning, and drive the intake motor 142 with a second intensity less than the first intensity while the heating device 250 is driven.

The cleaner 10 and the station 20 may each include a first sensor 150s and a second sensor 250s configured to face each other while the cleaner 10 is docked to the station 20.

The cleaner 10 may further include an outlet 112 configured to discharge air drawn in by the intake motor 142, and the outlet 112 may be positioned below the first sensor 150s.

The air discharged through the outlet 112 by driving the intake motor 142 may flow into a space between the first sensor 150s and the second sensor 250s.

The air blown toward the washing chamber 230 by driving the drying device 260 may flow into a space between the first sensor 150s and the second sensor 250s.

According to an embodiment of the disclosure, a method for controlling a cleaning system 1 may include: driving a heating device 250 of a station 20 to supply steam to a washing chamber 230 of the station 20 based on a start of a washing process, the washing chamber 230 configured to receive a mop 160 of a cleaner 10; and driving a drying device 260 of the station 20 while the steam is supplied to the washing chamber 230 to allow air to flow to a main body 110 of the cleaner 10, the drying device 260 configured to blow air toward the washing chamber 230.

The method for controlling the cleaning system 1 may further include: stopping driving the heating device 250 based on the end of the washing process, and driving the drying device 260 while the mop 160 is in a second position to perform a drying process.

The driving of the heating device 250 may include driving the heating device 250 in response to completion of lowering the mop 160 to a first position.

Lifting the mop 160 to the second position may include lifting the mop 160 to the second position in response to the heating device 250 stopping.

The method for controlling the cleaning system 1 may further include driving an intake motor 142 of the cleaner 10 while steam is supplied to the washing chamber 230.

The method for controlling the cleaning system 1 may further include driving the intake motor 142 with a first intensity while the cleaner 10 performs cleaning.

The driving of the intake motor 142 of the cleaner 10 while steam is supplied to the washing chamber 230 may include driving the intake motor 142 with a second intensity less than the first intensity.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the ‘non-transitory storage medium’ may include a buffer that temporarily stores data.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. A cleaning system, comprising:
a cleaner including:
a main body, and
a mop; and
a station to which the cleaner is dockable, the station including:
a washing chamber,
a water storage container,
a heating device, and
a drying device,
wherein the station is configured to, while the cleaner is docked to the station:
receive the mop in the washing chamber,
based on a start of a washing process, drive the heating device to heat water supplied from the water storage container to produce steam which is supplied to the washing chamber, and
while the steam is supplied to the washing chamber, drive the drying device to supply air to the washing chamber so that at least a portion of the air flows to the main body of the cleaner.

2. The cleaning system of claim 1, wherein
the cleaner is configured to:
based on the start of the washing process, lower the mop to a first position, and
based on an end of the washing process, lift the mop to a second position higher than the first position.

3. The cleaning system of claim 2, wherein
the air supplied to the washing chamber while the mop is in the first position flows relatively more to an outside of the washing chamber than to an inside of the washing chamber.

4. The cleaning system of claim 2, wherein
the station includes a guide member configured to:
divide a flow path of the air supplied to the washing chamber into a first flow path and a second flow path, and
contact the mop while the mop is in the first position so that air flowing through the first flow path is directed to an outside of the washing chamber and air flowing through the second flow path is directed to an inside of the washing chamber.

5. The cleaning system of claim 4, wherein
the guide member is configured to be spaced apart from the mop while the mop is in the second position so that the air flowing through the first flow path and the air flowing through the second flow path flows to the outside of the washing chamber and the inside of the washing chamber.

6. The cleaning system of claim 2, wherein
the station includes a guide member configured to:
divide a flow path of air supplied to the washing chamber into a first flow path and a second flow path,
contact the mop while the mop is in the first position so that the washing chamber is closed by the mop, and
be spaced apart from the mop while the mop is in the second position so that the washing chamber is open.

7. The cleaning system of claim 2, wherein
the station is configured to, based on the end of the washing process:
stop driving the heating device, and
drive the drying device while the mop is in the second position to perform a drying process.

8. The cleaning system of claim 2, wherein
the station is configured to drive the heating device in response to completion of lowering the mop to the first position.

9. The cleaning system of claim 2, wherein
the cleaner is configured to lift the mop to the second position in response to the heating device no longer being driven.

10. The cleaning system of claim 1, wherein
the cleaner includes an intake motor, and
the cleaner is configured to drive the intake motor while the steam is supplied to the washing chamber so that air introduced into the main body flows to an outside of the main body.

11. The cleaning system of claim 1, wherein
the cleaner includes a first sensor,
the station includes a second sensor, and
the first sensor and the second sensor are configured to face each other while the cleaner is docked to the station so as to sense the cleaner being docked to the station.

12. The cleaning system of claim 10, wherein
the cleaner includes a first sensor,
the station includes a second sensor,
the first sensor and the second sensor are configured to face each other while the cleaner is docked to the station so as to sense the cleaner being docked to the station,
the cleaner includes an outlet configured to discharge air drawn in by the intake motor, and
the outlet is positioned below the first sensor.

13. The cleaning system of claim 12, wherein
the air discharged through the outlet by driving the intake motor flows into a space between the first sensor and the second sensor.

14. The cleaning system of claim 12, wherein
a portion of the at least a portion of the air that flows to the main body of the cleaner flows into a space between the first sensor and the second sensor.

15. A method of controlling a cleaning system including a cleaner including a main body and a mop, and a station to which the cleaner is dockable, the station including a washing chamber, a water storage container, a heating device, and a drying device, the method comprising, while the cleaner is docked to the station:
receiving the mop in the washing chamber;
based on a start of a washing process, driving the heating device to heat water supplied from the water storage container to produce steam which is supplied to the washing chamber; and
while the steam is supplied to the washing chamber, driving the drying device to supply air to the washing chamber so that at least a portion of the air flows to the main body of the cleaner.
